(19) United States
(12) Patent Application Publication
(10) Pub. No.: US 2010/0207958 A1
(43) Pub. Date: Aug. 19, 2010

(54) COLOR IMAGE CREATING APPARATUS

(75) Inventors: Yoshikatsu KIMURA, Nisshin-shi (JP); Yoshiki NINOMIYA, Nagoya-shi (JP)

Correspondence Address: OLIFF & BERRIDGE, PLC, P.O. BOX 320850, ALEXANDRIA, VA, 22320-4850, US

(73) Assignee: KABUSHIKI KAISHI TOYOTA CHUO KENKYUSHO, Aichi-Ken (JP)

(21) Appl. No.: 12/705,095

(22) Filed: Feb. 12, 2010

(30) Foreign Application Priority Data
Feb. 17, 2009 (JP) 2009-033674

(51) Int. Cl. G09G 5/02

(52) U.S. Cl. 345/596

(57) ABSTRACT

A color image creating apparatus includes an acquisition unit and a creation unit. The acquisition unit acquires a color visible image from an imaging unit which images the color visible image which includes plural pixels which each include color information and intensity information based on light in a visible light range. The creation unit uses the intensity information and the color information which are acquired by the imaging for a pixel which has intensity equal to or higher than a predetermined value so as to effect display in color, and uses the intensity information acquired by the imaging for a pixel which has intensity lower than the predetermined value so as to effect display in grayscale, and create a color image.

### CROSS-REFERENCE TO RELATED APPLICATIONS

This application claims priority under 35 USC 119 from Japanese Patent Application No. 2009-033674 filed on Feb. 17, 2009, the disclosure of which is incorporated by reference herein.

### BACKGROUND OF THE INVENTION

1. Field of the Invention

The invention relates to a color image creating apparatus. In particular, the invention relates to a color image creating apparatus that creates a color image.

2. Description of the Related Art

As conventional color imaging apparatuses, a color imaging apparatus is known that may be used both day and night and combines both daytime color reproducibility and nighttime sensitivity (Japanese Patent Application Laid-Open (JP-A) No. 2005-6066). In the color imaging apparatus, one G filter of four RGBG pixels composing one unit of a normal Bayer array is replaced by an IR filter, an RGB filter is sorted into a first mode, and the IR filter is sorted into a second mode. An infrared cut filter is provided to the three pixels of RGB.

In the technique described in the above publication, however, since the RGB filter and the IR filter are selectively used according to mode, only a monochrome image with low visibility using only the IR filter is provided under a dark environment such as at nighttime.

As a conventional color image creating apparatus, a color image reproduction apparatus that reproduces a color image having suitable color information and intensity information is known (JP-A No. 2007-184805). In the color image reproduction apparatus, an infrared component is eliminated from visible image data and color information (hue and saturation) is extracted, and the color information is synchronized with infrared intensity information or visible intensity information so that a color image is reproduced.

However, in the technique of the above publication, only one of a visible image and an infrared image is selected according to a mode specified by a user in advance, and the intensity information for the selected image is extracted. When imaging is carried out by a color camera and an infrared camera, the light quantity of infrared light occasionally becomes lower than the light quantity of visible light in a bright place where illumination or the like is present. In this case, when the intensity of the infrared light is selected, it becomes darker than the intensity of the visible light, resulting in deteriorated visibility.

### SUMMARY OF THE INVENTION

The present invention has been made in view of the above circumstances and provides a color image creating apparatus.

According to an aspect of the invention, there is provided a color image creating apparatus including: an acquisition unit which acquires a color visible image from an imaging unit which images the color visible image based on light in a visible light range, the color visible image comprising a plurality of pixels which each include color information and intensity information; and a creation unit which uses the intensity information acquired by the imaging and the color information acquired by the imaging for a pixel included in the color visible image which has intensity equal to or higher than a predetermined value so as to effect display in color, and uses the intensity information acquired by the imaging for a pixel included in the color visible image which has lower intensity than the predetermined value so as to effect display in grayscale, and creates a color image.

### BRIEF DESCRIPTION OF THE DRAWINGS

FIG. 1 is a diagram illustrating a structure of a color image creating apparatus according to a first exemplary embodiment;

FIG. 2 is a function block diagram illustrating the color image creating apparatus according to the first exemplary embodiment;

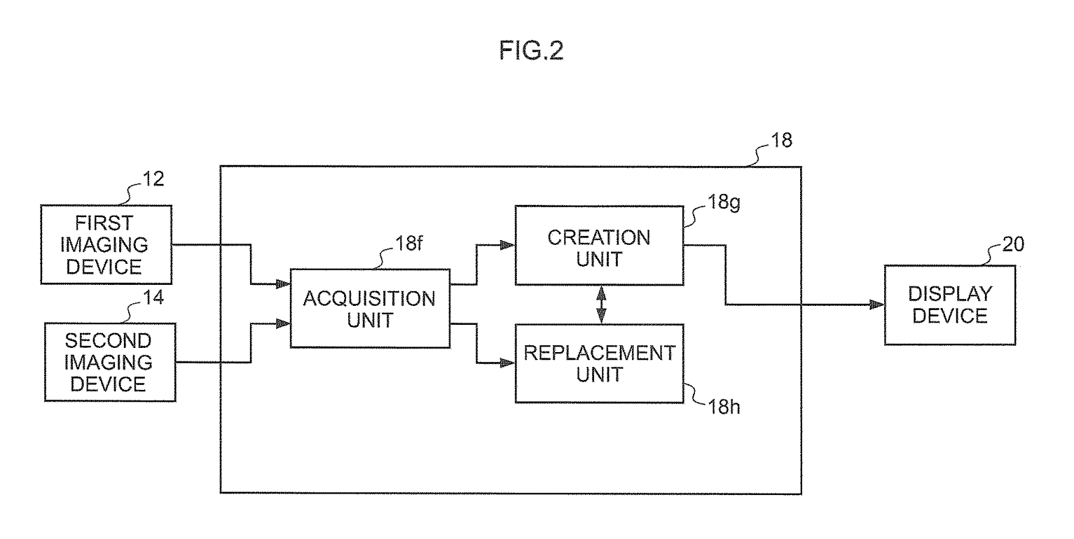

FIG. 3 is a flowchart illustrating a process for creating a color image to be executed by the color image creating apparatus according to the first exemplary embodiment;

FIGS. 4A to 4D illustrate examples of a screen to be displayed by the color image creating apparatus according to the first exemplary embodiment;

FIG. 5 is a flowchart illustrating the process for creating a color image to be executed by the color image creating apparatus according to a second exemplary embodiment;

FIG. 6 is a functional block diagram illustrating the color image creating apparatus according to the second exemplary embodiment;

FIG. 7 is a flowchart illustrating the process for creating a color image to be executed by the color image creating apparatus according to a third exemplary embodiment;

FIG. 8 is a functional block diagram illustrating the color image creating apparatus according to the third exemplary embodiment;

FIG. 9 is a flowchart illustrating the process for creating a color image to be executed by the color image creating apparatus according to a fourth exemplary embodiment;

FIG. 10 is a functional block diagram illustrating the color image creating apparatus according to the fourth exemplary embodiment;

FIG. 11 is a flowchart illustrating the process for creating a color image to be executed by the color image creating apparatus according to a fifth exemplary embodiment;

FIG. 12 is a functional block diagram illustrating the color image creating apparatus according to the fifth exemplary embodiment;

FIG. 13 is a flowchart illustrating the process for creating a color image to be executed by the color image creating apparatus according to a sixth exemplary embodiment;

FIG. 14 is a functional block diagram illustrating the color image creating apparatus according to the sixth exemplary embodiment;

FIG. 15 is a flowchart illustrating the process for creating a color image to be executed by the color image creating apparatus according to a seventh exemplary embodiment;

FIG. 16 is a functional block diagram illustrating the color image creating apparatus according to the seventh exemplary embodiment;

FIG. 17 is a flowchart illustrating the process for creating a color image to be executed by the color image creating apparatus according to an eighth exemplary embodiment;

FIG. 18 is a functional block diagram illustrating the color image creating apparatus according to the eighth exemplary embodiment;

FIG. 19 is a flowchart illustrating the process for creating a color image to be executed by the color image creating apparatus according to a ninth exemplary embodiment;

FIG. 20 is a functional block diagram illustrating the color image creating apparatus according to the ninth exemplary embodiment;

FIG. 21 is a flowchart illustrating the process for creating a color image to be executed by the color image creating apparatus according to a tenth exemplary embodiment;

FIG. 22 is a functional block diagram illustrating the color image creating apparatus according to the tenth exemplary embodiment; and

FIG. 23 illustrates one example illustrating a screen to be displayed by the color image creating apparatus according to the tenth exemplary embodiment.

### DETAILED DESCRIPTION OF THE INVENTION

Exemplary embodiments of the present invention are described in detail below with reference to the accompanying drawings.

### First Exemplary Embodiment

A first exemplary embodiment is described. The first exemplary embodiment describes an example where the invention is applied to an imaging system that is mounted to a vehicle and that creates and displays a color image based on an image acquired by imaging a scene ahead of the vehicle. Hereinafter, the imaging system is called a color image creating apparatus.

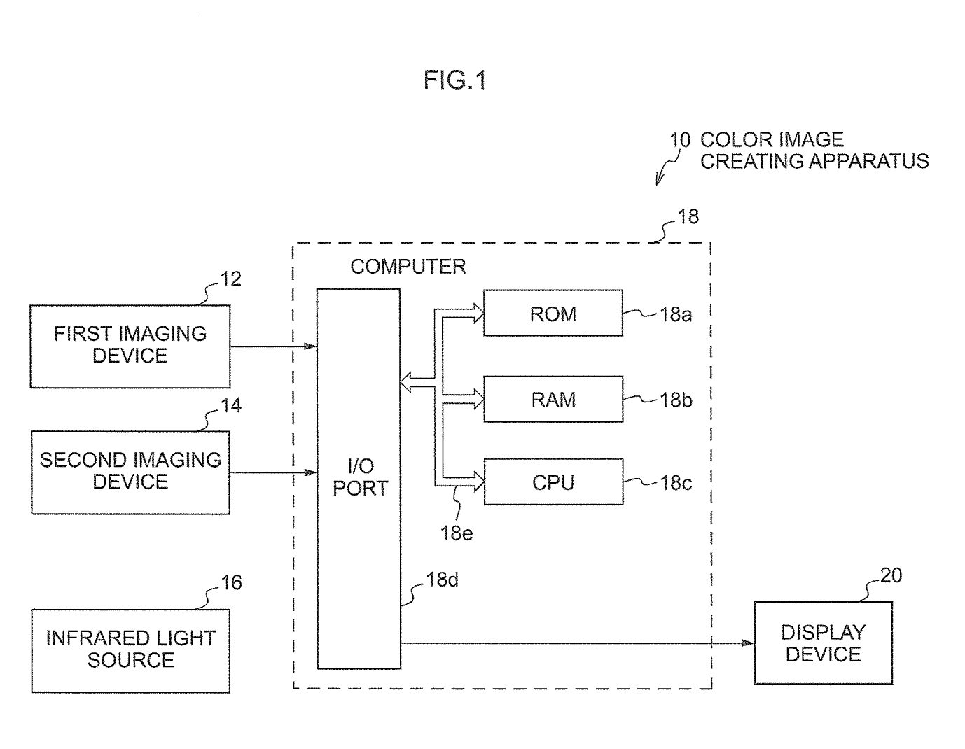

As shown in FIG. 1, a color image creating apparatus 10 according to the first exemplary embodiment has a first imaging device 12, a second imaging device 14, an infrared ray light source 16, a computer 18, and a display device 20.

The first imaging device 12 has a CCD camera that images a scene ahead of the vehicle to output a color visible image (visible light image), and that is mounted to image a scene ahead of the vehicle. The first imaging device 12 has plural light emitting elements that output signals according to light entering respective pixels arranged two dimensionally. The first imaging device 12 converts the signals output from the plural light receiving elements into digital signals, and creates to output image data of a color visible image. The color visible image includes plural pixels which each include color information and intensity information. That is to say, the first imaging device 12 images to output a color visible image which includes plural pixels which each include color information and intensity information based on light in a visible light region. In the first exemplary embodiment, the color information includes saturation and hue, for example. In the first exemplary embodiment, the intensity information includes intensity (intensity value, luminance), and the intensity information represents intensity.

The second imaging device 14 has a filter that, among incident light, transmits light within a near-infrared light waveband, and a CCD camera. The second imaging device 14 is mounted so as to image scenes ahead of the vehicle. The filter (not shown) that transmits light within a near-infrared light waveband is disposed so as to be opposed to a lens surface of the second imaging device 14. The second imaging device 14 has plural light receiving elements that output signals according to light entering the respective pixels arranged two dimensionally. The second imaging device 14 converts the signals output from the plural light receiving elements into digital signals, and creates an output image data of an infrared image which includes the plural pixels which each include intensity information (intensity and pixel value). That is to say, the second imaging device 14 images to output the infrared image which includes of the plural pixels which each include intensity information based on the light in the near-infrared region.

The first imaging device 12 and the second imaging device 14 correspond to an imaging unit.

When imaging is performed by the second imaging device 14, the infrared light source 16 illuminates light in the near-infrared region (light including near-infrared light) to the front of the vehicle.

The computer 18 controls the display device 20 so that an image process is executed on a color visible image imaged by the first imaging device 12 and an infrared image imaged by the second imaging device 14, a color image is created and displayed.

The computer 18 entirely controls the color image creating apparatus 10. The computer 18 has a ROM (Read Only Memory) 18a, a RAM (Random Access Memory) 18b, a CPU (Central process Unit) 18c, and an I/O (input/output) port 18d. The ROM 18a, the CPU 18b, the RAM 18c and the I/O port 18d are connected to each other via a bus 18e.

A basic program such as OS is stored in the ROM 18a as a storage medium. A program that executes a process routine of the color image creating process described in detail below is stored in the ROM 18a.

The CPU 18c retrieves the program from the ROM 18a and performs the process. Various data are temporarily stored in the RAM 18b.

When the computer 18 is represented by a functional block according to the process for creating a color image described in detail below, it is represented by an acquisition unit 18f, a creation unit 18g, and a replacement unit 18h.

The acquisition unit 18f acquires a color visible image and an infrared image from the imaging units of the first imaging device 12 and the second imaging device 14.

The creation unit 18g creates a color image in the following manner. The intensity information and the color information, that are acquired by the imaging are used for a pixel which is included in the color visible image and which has intensity equal to or higher than a predetermined value so as to effect display in color. The intensity information acquired by the imaging is used for a pixel which is included in the color visible image and which has intensity lower than the predetermined value so as to effect display in grayscale. The creation unit 18g further creates another color image in the following manner. Intensity information which represents the intensity after replacement and corresponding color information of the color image are used for the pixel of the color image whose intensity is replaced by the replacement unit 18h. The intensity information acquired by the imaging and the corresponding color information of the color image are used for the pixel of the color image whose intensity is not replaced by the replacement unit 18h.

The replacement unit 18h replaces the intensity of the pixel which is included in the color image created by the creation unit 18g and which has intensity lower than the intensity of the corresponding pixel of the infrared image with the intensity of the corresponding pixel of the infrared image.

The display device 20 includes an LCD (Liquid Crystal Display) that displays an image based on input data. An image is displayed on the display device 20 under the control of the computer 18.

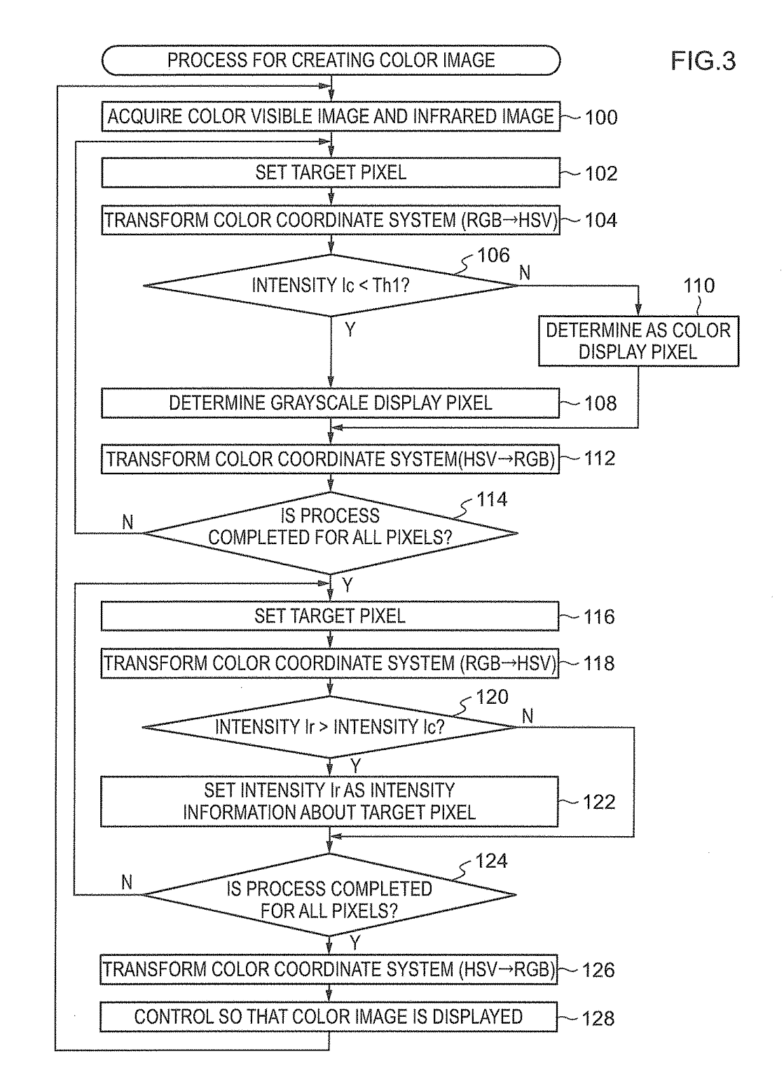

A process routine for creating a color image to be executed by the CPU 18c of the computer 18 is described below with reference to FIG. 3. In the first exemplary embodiment, the infrared light source 16 emits light in a near-infrared range to the front of the vehicle, and when the first imaging device 12 and the second imaging device 14 sequentially image scenes ahead of the vehicle, the CPU 18c executes the process for creating a color image shown in FIG. 3.

Image data of the color visible image imaged by the first imaging device 12 is acquired, and image data of the infrared image imaged by the second imaging device 14 is acquired at step 100. As a result, the color visible image and the infrared image are acquired from the imaging units of the first imaging device 12 and the second imaging device 14. Step 100 corresponds to an acquisition unit.

At step 102, a pixel which is not processed at steps 104 or later steps described in detail below is set as a target pixel for the color visible image acquired at step 100.

The image data of the pixel of the color visible image set as the target pixel at step 102 is transformed from a RGB space into an HSV space, so that the color information (saturation and hue) and the intensity information (intensity) of the pixel is extracted at step 104.

The intensity Ic of the target pixel in the color visible image extracted at step 104 is compared with a predetermined value Th1, so that a determination is made at step 106 whether the intensity Ic is lower than the predetermined value Th1 (the intensity Ic is lower than the predetermined value Th1). In the first exemplary embodiment, a certain value is empirically acquired in advance, and the acquired certain value is set as the predetermined value Th1 in advance. When a pixel has lower intensity than the certain value, the amount of color information for the pixel is small (insufficient), and thus the pixel is not suitable for color display (namely, the visibility of a displayed color image is low). Further, when a pixel has intensity equal to or higher than the certain value, an information amount of the color information for the pixel is large, and thus the pixel is suitable for color display (namely, the visibility of a displayed color image is high). It is considered that the color information of the pixel having intensity lower than the predetermined value Th1 does not include a sufficient amount of information for coloring, and thus if coloring is performed in this state, the coloring becomes unnatural.

When the determination is made at step 106 that the intensity Ic is lower than the predetermined value Th1, the color information for the target pixel in the color visible image set at step 102 is determined as unsuitable to be displayed in color. The sequence goes to step 108.

The target pixel in the color visible image set at step 102 is determined as a grayscale display pixel at step 108. The target pixel in the color visible image determined as the grayscale display pixel is displayed in grayscale at step 128 described in detail below. The sequence goes to step 112.

On the other hand, when the determination is made at step 106 that the intensity Ic is equal to or higher than the predetermined value Th1, the color information for the target pixel in the color visible image set at step 102 is determined as suitable for color display. The sequence goes to step 110.

The target pixel in the color visible image set at step 102 is determined as a color display pixel at step 110. The target pixel in the color visible image determined as the color display pixel is displayed in color at step 128 described in detail below. The sequence goes to step 112.

As to the pixel of the color visible image which is set as the target pixel at step 102 and which is determined as the color display pixel at step 110, the image data of the pixel is transformed from an HSV space into a RGB space. As to the pixel of the color visible image which is set as the target pixel at step 102 and which is determined as the grayscale display pixel at step 108, the value (brightness, intensity) of the pixel is converted to set as data of R, G and B. In such a manner, the image data is transformed from the HSV space into the RGB space. As a result, the RGB image data of the pixel of the color visible image set as the target pixel at step 102 may be acquired. As to the pixel of the color visible image which is set as the target pixel at step 102 and which is determined as the grayscale display pixel at step 108, after the value of the saturation of the pixel is changed to 0 and the value of the hue is changed to a value representing a predetermined color (without changing the value (brightness, intensity)), the image data of the pixel may be transformed from the HSV space into the RGB space at step 112.

A determination is made at step 114 whether the process at each step (steps 102, 104, 106, 108 when determined as positive at 106, 110 when determined as negative at step 106, and 112) is completed for all the pixels. When the process is not completed for all the pixels, the sequence returns to step 102, and another pixel which is not to be processed is set as a target pixel. On the other hand, when the process at all steps is completed for all the pixels at step 114, the sequence goes to step 116.

In the process at steps 102, 104, 106, 108, 110, 112 and 114, the color image is created in the following manner. The intensity information acquired by the imaging (the intensity information extracted at step 104) and the color information acquired by the imaging (the color information extracted at step 104) are used for the pixel which is included in the color visible image and which has the intensity equal to or higher than the predetermined value Th1 so as to effect display in color. Further, the intensity information acquired by the imaging is used for the pixel which is included in the color visible image and which has the intensity lower than the predetermined value Th1 so as to effect display in grayscale. Note that “to create the color image” means “to create the image data of the color image”.

A pixel in a corresponding position in the created color image and the infrared image acquired at step 100 is set as the target pixel at step 116. The pixel to be set as the target pixel at step 116 is a pixel which is not subject to the process at step 118 or later steps described in detail below. The target pixel in the infrared image which corresponds to the target pixel in the color image refers as a corresponding pixel.

The image data of the pixel of the color image set as the target pixel at step 116 is transformed from the RGB space to the HSV, so that the color information (saturation and hue) and the intensity information (value (brightness, intensity)) of the pixel of the color image set as the target pixel at step 116 is extracted at step 118.

The intensity Ic of the target pixel in the color image set at step 116 is compared with the intensity Ir of the target pixel in the infrared image set at step 116, so that a determination is made at step 120 whether the intensity Ic is lower than the intensity Ir.

When the determination is made at step 120 that the intensity Ic is lower than the intensity Ir, the sequence goes to step 122. On the other hand, when the determination is made at step 120 that the intensity Ic is equal to or higher than the intensity Ir, the sequence goes to step 124.

The intensity Ic of the target pixel in the color image is replaced with the intensity Ir of the infrared image at step 122. The sequence then goes to step 124.

A determination is made at step 124 whether the process at each step (steps 116, 118, 120, and 122 when determined as positive at 122) is completed for all the pixels. When the process is not completed for all the pixels, the sequence returns to step 116, and another pixel which is not subject to the process is set as the target pixel. On the other hand, when the determination is made at step 124 that the process at each step is completed for all the pixels, the sequence goes to step 126.

In the process at steps 116, 118, 120, 124 and 124, the intensity Ic of the pixel which is included in the color image and which has intensity lower than the intensity Ir of the corresponding pixel of the infrared image is replaced by the intensity Ir of the corresponding pixel.

The image data of the pixel of the color image is transformed from the HSV space to the RGB space at step 126. The intensity information representing the intensity replaced at step 122 and the color information (corresponding color information of the color image) extracted at step 118 are used for a pixel of the color image whose intensity is replaced at step 122, and the intensity information and the color information that are extracted at step 118 are used for a pixel of the color image whose intensity is not replaced at step 122. As a result, the RGB image data of the color image can be again acquired, thereby another color image is further created.

The display on the display device 20 is controlled at step 128 so as to display the color image created by using the acquired RGB image data at step 126. The sequence returns to step 100.

In the process at steps 126 and 128, another color image is further created. The intensity information representing the intensity after replacement and the corresponding color information of the color image are used for the pixels of the color image whose intensity is replaced at step 122. The intensity information acquired by the imaging and the corresponding color information of the color image are used for pixels of the color image whose intensity is not replaced at step 122.

The process for creating a color image according to the first exemplary embodiment is described above. Step 100 is executed by the acquisition unit 18f, and steps 102, 104, 106, 108, 110, 112, 114, 126, and 128 are executed by the creation unit 18g. Steps 116, 118, 120, 122, and 124 are executed by the replacement unit 18h.

The color image creating apparatus 10 according to the first exemplary embodiment creates a color image. The intensity information and the color information that are acquired by the imaging are used for the pixel of the color visible image having the color information suitable for color display (namely, the pixel of the color visible image which has intensity Ic is equal to or higher than the predetermined value Th1) so as to effect display in color. The intensity information acquired by the imaging is used for the pixel of the color visible image having the color information unsuitable for color display (namely, the pixel of the color visible image which has intensity Ic lower than the predetermined value Th1) so as to effect display in grayscale.

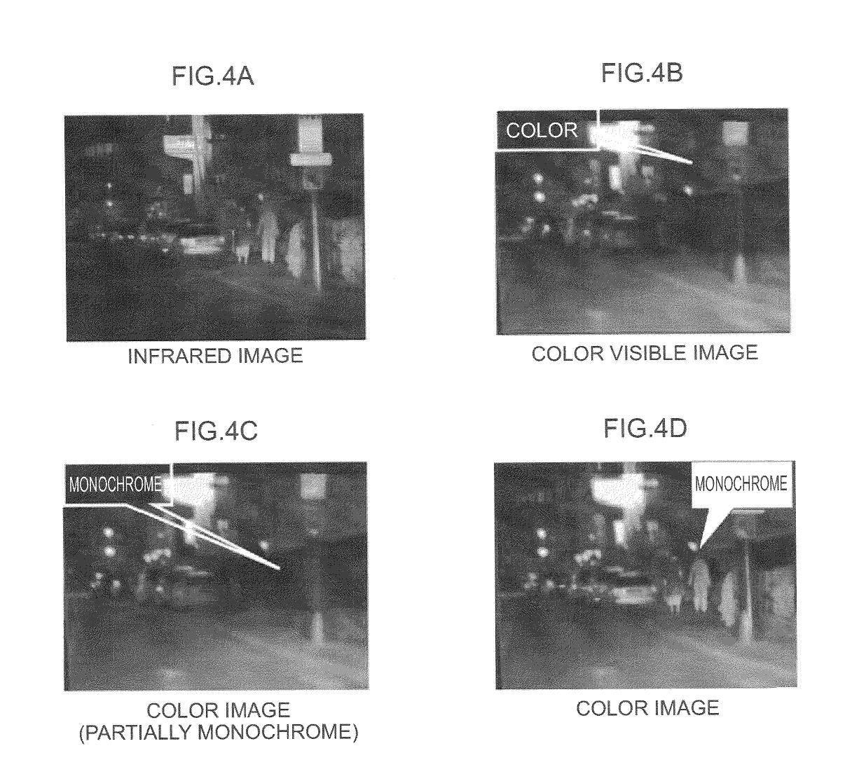

In the color image creating apparatus 10 according to the first exemplary embodiment, when an infrared image shown in FIG. 4A and a color visible image shown in FIG. 4B are acquired at step 100, a color image, which is partially monochrome (grayscale) as shown in FIG. 4C, is created at steps 102, 104, 106, 108, 110, 112, and 114. Therefore, an image having better visibility may be obtained by using the color image creating apparatus 10 according to the first exemplary embodiment.

Another color image is further created at steps 126 and 128 in the following manner. The intensity Ic of the pixel of the color image is compared with the intensity Ir of the pixel of the infrared image corresponding to that pixel, and the intensity Ic of the pixel which is included in the color image and which has intensity lower than the intensity Ir of the corresponding pixel of the infrared image is replaced by intensity for providing good visibility. For example, as shown in FIG. 4D, a color image having better visibility is created and is displayed on the display device 20.

The first exemplary embodiment describes the example where the color image created at steps 102, 104, 106, 108, 110, 112, and 114 is subject to the process at steps 116, 118, 120, 122, and 124, and another color image is further created at steps 126 and 128. However, the invention is not limited to this. For example, the display device 20 may be controlled so as to display the color image created at steps 102, 104, 106, 108, 110, 112, and 114.

The first exemplary embodiment describes the example where the intensity Ic of the pixel which is included in the color image and which has intensity lower than the intensity Ir of the corresponding pixel of the infrared image is replaced by the intensity Ir of the corresponding pixel at steps 116, 118, 120, 122, and 124. However, the invention is not limited to this. The intensity Ic of the pixel which is included in the color image and which is lower than the intensity Ir of the corresponding pixel of the infrared image may be replaced by a weighted mean of the intensity Ic of the pixel which is included in the color image and the intensity Ir of the corresponding pixel of the infrared image. In this case, both the pixels are weighted in a predetermined manner. As a result, when the intensity Ir is saturated, the saturation of the intensity may be repressed.

### Second Exemplary Embodiment

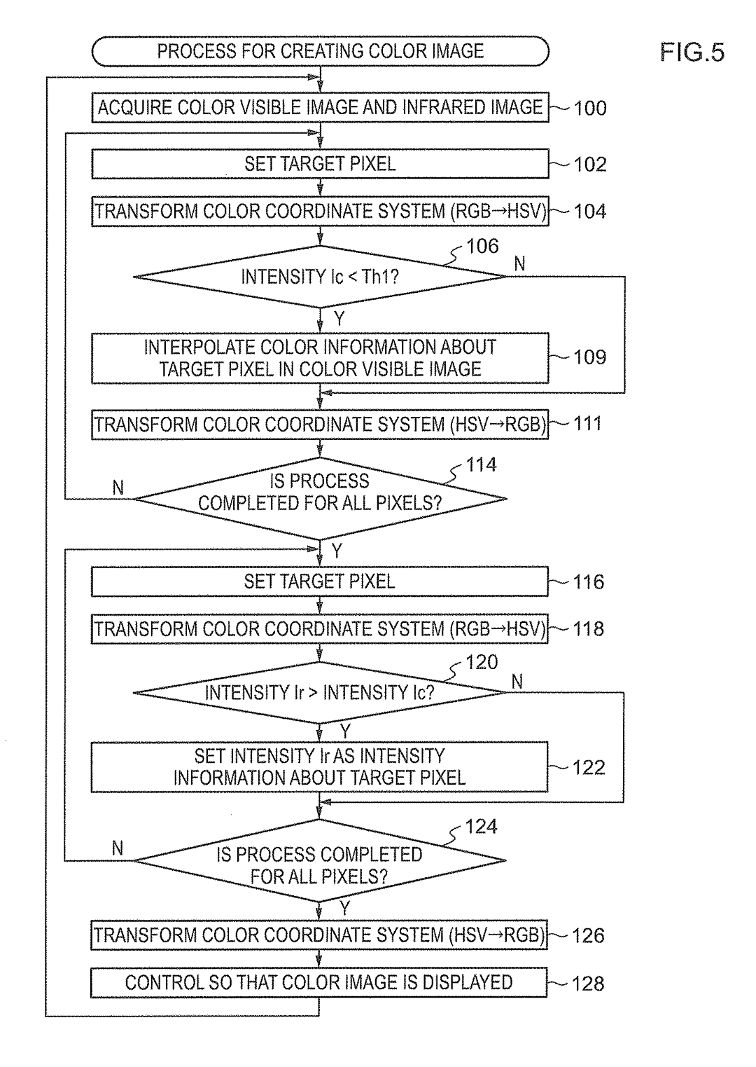

A second exemplary embodiment is described. Description about the similar structure and process to those in the first exemplary embodiment is occasionally omitted. The identical reference symbols are given to them, and the description is occasionally omitted. A different point between the first exemplary embodiment and the second exemplary embodiment is described. In the first exemplary embodiment, the program for executing the process routine for creating a color image shown in FIG. 3 is stored in the ROM 18a, and the CPU 18c executes the process for creating a color image shown in FIG. 3. On the other hand, in the second exemplary embodiment, a program for executing the process routine for creating a color image shown in FIG. 5 is stored in the ROM 18a. The CPU 18c retrieves the program for executing the process routine for creating a color image shown in FIG. 5 from the ROM 18a so as to execute the process for creating a color image shown in FIG. 5. A different point in the second exemplary embodiment from the first exemplary embodiment is that the process for creating a color image shown in FIG. 5 is executed.

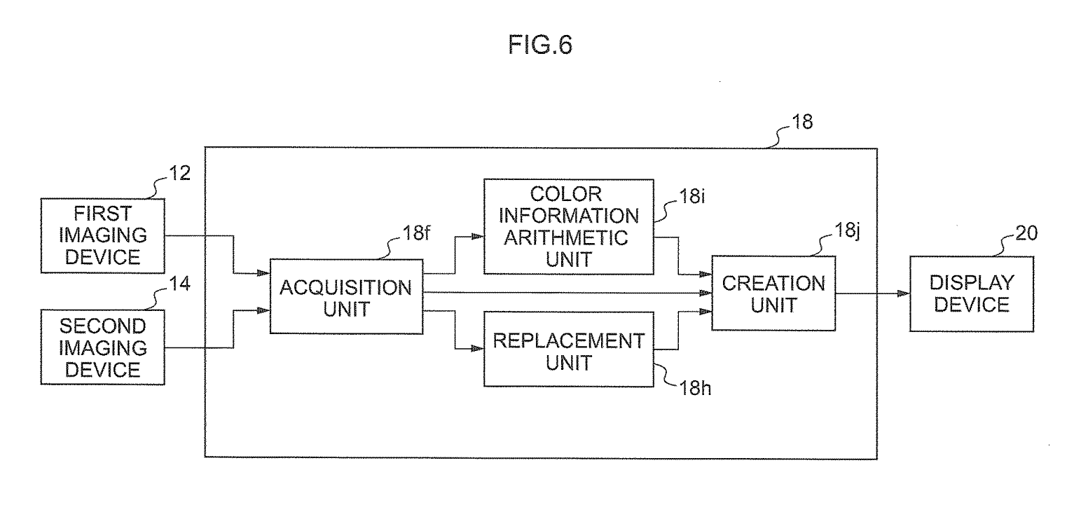

The computer 18 is represented by a functional block according to the process for creating a color image shown in FIG. 5 described in detail below. That is to say, as shown in FIG. 6, the computer 18 is configured by the acquisition unit 18f, a color information arithmetic unit 18i, the replacement unit 18h and a creation unit 18j.

The color information arithmetic unit 18i interpolates color information for a pixel which is included in a color visible image and which has intensity lower than the predetermined value using color information for pixels circumjacent to that pixel which have intensity equal to or higher than the predetermined value. In such a manner, the color information arithmetic unit 18i calculates the color information for the pixel which is included in the color visible image and which has the intensity lower than predetermined value.

The creation unit 18i creates a color image. The calculated color information and the intensity information acquired by the imaging are used for a pixel which is included in the color visible image and whose color information is calculated by the color information arithmetic unit 18i. The color information and the intensity information that are acquired by the imaging are used for a pixel which is included in the color visible image and whose color information is not calculated by the color information arithmetic unit 18i.

The process routine for creating a color image shown in FIG. 5 to be executed by the CPU 18c of the computer 18 is described.

Similarly to the first exemplary embodiment, steps 100, 102, 104, and 106 are executed.

When the determination is made at step 106 that the intensity Ic is lower than the predetermined value Th1, the color information for the target pixel in the color visible image set at step 102 is not color information suitable for color display. The sequence goes to step 109.

Pixels circumjacent to the target pixel in the color visible image set at step 102 (for example, pixels in a region of 128 pixels by 128 pixels in which the target pixel is set as a center) having intensity equal to or higher than the predetermined value Th1 are specified at step 109. The color information for the target pixel in the color visible image set at step 102 is interpolated by using the color information for the specified pixels. As a result, the color information for the target pixel in the color visible image having the intensity lower than the predetermined value Th1 is calculated. As a result, the color information for the target pixel in the color visible image having the intensity lower than the predetermined value Th1 becomes information suitable for color display. The sequence goes to step 111.

On the other hand, when the determination is made at step 106 that the intensity Ic is equal to or higher than the predetermined value Th1, the color information for the target pixel in the visible color image set at step 102 is determined as the color information suitable for color display. The sequence goes to step 111.

When the pixel of the color visible image set as the target pixel at step 102 is a pixel whose color information is calculated at step 109, image data of the target pixel set at step 102 is transformed from the HSV space to the RGB space at step 111 by using the color information calculated at step 109 and the intensity information extracted at step 104 (the intensity information acquired by the imaging). When the pixel of the color visible image set as the target pixel at step 102 is a pixel whose color information is not calculated at step 109, the image data of the target pixel set at step 102 is transformed from the HSV space to the RGB space at step 111 by using the color information and the intensity information that are extracted at step 104. As a result, RGB image data of the pixel in the color visible image set as the target pixel at step 102 may be acquired.

A determination is made at step 114 whether the process at each step (steps 102, 104, 106, 109 when determined as positive at 106, and 111) is completed for all the pixels. When the process is not completed for all the pixels, the sequence returns to step 102, so that another pixel which is not processed is set as the target pixel. On the other hand, when the determination is made at step 114 that the process at each step is completed for all the pixels, the sequence goes to step 116. Since the process after step 116 or later is similar to that in the first exemplary embodiment, the description thereof is omitted.

As described above, in the process at steps 102, 104, 106 and 109, the color information for the pixel which is included in the color visible image and which has the intensity lower than the predetermined value Th1 is interpolated by using the color information for the pixels circumjacent to that pixel which have intensity equal to or higher than the predetermined value Th1. As a result, the color information for the pixel which is included in the color visible image and which has the intensity lower than the predetermined value Th1 is calculated.

In the process at steps 111 and 114, a color image is created. The calculated color information and the intensity information acquired by the imaging are used for the pixel whose color information is calculated at step 109. The color information and the intensity information that are acquired by the imaging are used for the pixel in the color visible image whose color information is not calculated at step 109.

The process for creating a color image according to the second exemplary embodiment is described above. Steps 102, 104, 106, and 109 are executed by the color information arithmetic unit 18i, and steps 111, 114, 126, and 128 are executed by the creation unit 18j.

In the color image creating apparatus 10 according to the second exemplary embodiment, a color image is created in the following manner. The color information for the pixel of the color visible mage as the information unsuitable for color display (namely, the pixel of the color visible image having the intensity lower than the predetermined value Th1) is calculated by interpolation using the color information for the pixels of the color visible image as the information suitable for color display (namely, the pixels of the color visible image having the intensity equal to or higher than the predetermined value Th1). The calculated color information and the intensity information acquired by the imaging are used for the pixel which is included in the color visible image and whose color information is calculated at step 109. The color information and the intensity information that are acquired by the imaging are used for the pixel which is included in the color visible image and whose color information is not calculated at step 109.

Therefore, an image with better visibility may be obtained by using the color image creating apparatus 10 according to the second exemplary embodiment.

The second exemplary embodiment describes the example where the color image created in the process at steps 102, 104, 106, 109, 111, and 114 is subject to the process at steps 116, 118, 120, 122, and 124, so that another color image is further created at steps 126 and 128 to be displayed. The invention is not, however, limited to this. For example, the display device 20 may be controlled so as to display the color image created by the process at steps 102, 104, 106, 109, 111 and 114.

### Third Exemplary Embodiment

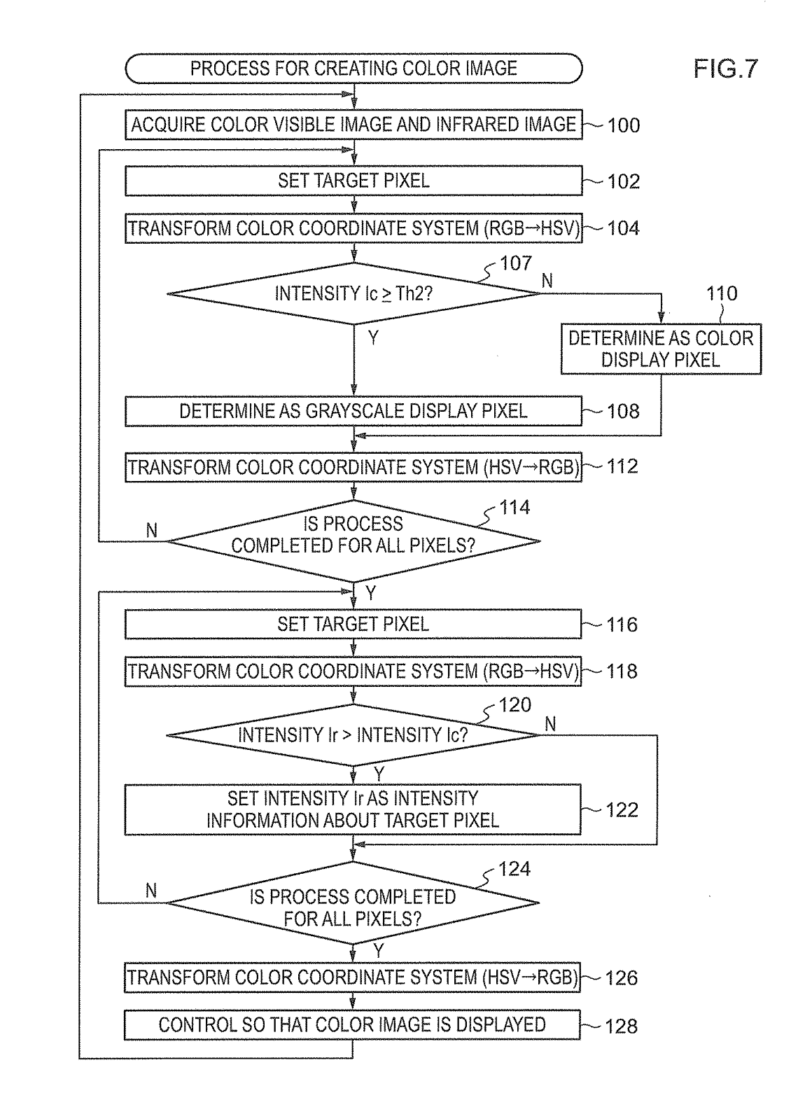

A third exemplary embodiment is described below. The structure and the process similar to those in the first and second exemplary embodiments are occasionally omitted. The identical reference symbols are given to them, and their description is occasionally omitted. A different point between the first and third exemplary embodiments is described. In the first exemplary embodiment, the program for executing the process routine for creating a color image shown in FIG. 3 is stored in the ROM 18a, and the CPU 18c executes the process for creating a color image shown in FIG. 3. On the other hand, in the third exemplary embodiment, a program for executing the process routine for creating a color image shown in FIG. 7 is stored in the ROM 18a. The CPU 18c retrieves the program for executing the process routine for creating a color image shown in FIG. 7 from the ROM 18a so as to execute the process for creating a color image shown in FIG. 7. The different point in the third exemplary embodiment from the first exemplary embodiment is that the process for creating a color image shown in FIG. 7 is executed.

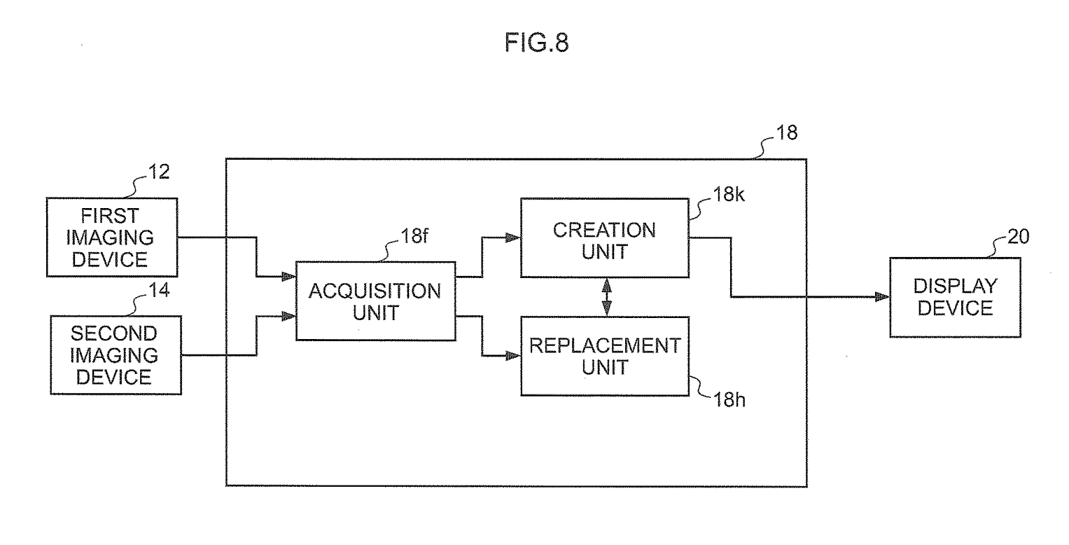

The computer 18 is represented by the functional block according to the process for creating a color image shown in FIG. 7 described in detail below. The computer 18 is configured by the acquisition unit 18f, a creation unit 18k, and the replacement unit 18h as shown in FIG. 8.

The creation unit 18k creates a color image. Intensity information acquired by imaging is used for a pixel which is included in a color visible image and which has intensity equal to or higher than the predetermined value so as to effect display in grayscale. The intensity information and color information that are acquired by imaging are used for a pixel which is included in the color visible image and which has intensity lower than the predetermined value for color display.

The process routine for creating a color image shown in FIG. 7 to be executed by the CPU 18c of the computer 18 is descried.

Similarly to the first exemplary embodiment, steps 100, 102, and 104 are executed.

The intensity Ic of the target pixel in the color visible image extracted at step 104 is compared with a predetermined value Th2 so that a determination is made at step 107 that the intensity Ic is equal to or higher than the predetermined value Th2. In the third exemplary embodiment, a certain value is experimentally acquired in advance, and the acquired certain value is set as the predetermined value Th2 in advance. This certain value is acquired as follows. When the intensity is equal to or higher than the certain value, halation occurs on the pixel (the intensity of the pixels is saturated), and thus an amount of the color information is reduced. As a result, the pixel is not suitable for color display (namely, the visibility of a displayed color image is low). When the intensity is lower than the certain value, the amount of the color information for the pixel is large, and thus the pixel is suitable for color display (namely, the visibility of a displayed color image is high). It is considered that the color information for the pixel which has the intensity equal to or higher than the predetermine value Th2 does not include a sufficient amount of information for coloring, and thus forcible coloring becomes unnatural.

When the determination is made at step 107 that the intensity Ic is equal to or higher than the predetermined value Th2, the determination is made that the color information for the target pixel in the visible color image set at step 102 is not suitable for color display. Se sequence goes to step 108.

Similarly to the first exemplary embodiment, the target pixel in the color visible image set at step 102 is determined as a grayscale display pixel at step 108. The target pixel in the color visible image determined as the grayscale display pixel is displayed in grayscale at step 128 described in detail below. The sequence goes to step 112.

On the other hand, when the determination is made at step 107 that the intensity Ic is lower than the predetermined value Th2, the determination is made that the color information for the target pixel in the color visible image set at step 102 is suitable for color display. The sequence goes to step 110.

Similarly to the first exemplary embodiment, the target pixel in the color visible image set at step 102 is determined as a color display pixel at step 110. The target pixel in the color visible image set as the color display pixel is displayed in color at step 128 described in detail below. The sequence goes to step 112.

Similarly to the first exemplary embodiment, image data of the pixel in the color visible image set as the target pixel at step 102 is transformed from the HSV space to the RGB space at step 112.

A determination is made at step 114 whether the process at each step (steps 102, 104, 107, 108 when determined as positive at 107, 110 when determined as negative at steps 107, and 112) is completed for all the pixels. When the process is not completed for all the pixels, the sequence returns to step 102, and another pixel which is not subject to the process is set as the target pixel. On the other hand, when the process at each step is completed for all the pixels at step 114, the sequence goes to step 116.

In the process at steps 102, 104, 107, 108, 110, 112, and 114, a color image is created. Intensity information acquired by imaging is used for a pixel which is included in a color visible image and which has intensity equal to or higher than the predetermined value Th2 so as to effect display in grayscale. The intensity information and color information that are acquired by the imaging are used for a pixel which is included in the color visible image and which has intensity lower than the predetermined value Th2 so as to effect display in color.

Since the subsequent steps (steps 116, 118, 120, 122, 124, 126, and 128) are similar to those in the first exemplary embodiment, the description thereof is omitted.

The process for creating a color image according to the third exemplary embodiment is described above. The creation unit 18k executes steps 102, 104, 107, 108, 110, 112, 114, 126, and 128.

In the color image creating apparatus 10 according to the third exemplary embodiment, a color image is created. The intensity information and the color information that are acquired by the imaging are used for the pixel of the color visible image as color information suitable for color display (namely, the pixel of the color visible image having the intensity lower than the predetermined value Th2) so as to effect display in color. The intensity information acquired by the imaging is used for the pixel of the color visible image as color information unsuitable for color display (namely, the pixel of the color visible image having the intensity equal to or higher than the predetermined value Th2) so as to effect display in grayscale.

Therefore, an image having good visibility may be obtained by using the color image creating apparatus 10 according to the third exemplary embodiment.

The third exemplary embodiment describes the example where the color image created at steps 102, 104, 107, 108, 110, 112, and 114 is subject to the process at steps 116, 118, 120, 122, and 124, and another color image is further created and displayed at steps 126 and 128. However, the invention is not limited to this. For example, the display device 20 may be controlled so as to display the color image created at steps 102, 104, 107, 108, 110, 112, and 114.

### Fourth Exemplary Embodiment

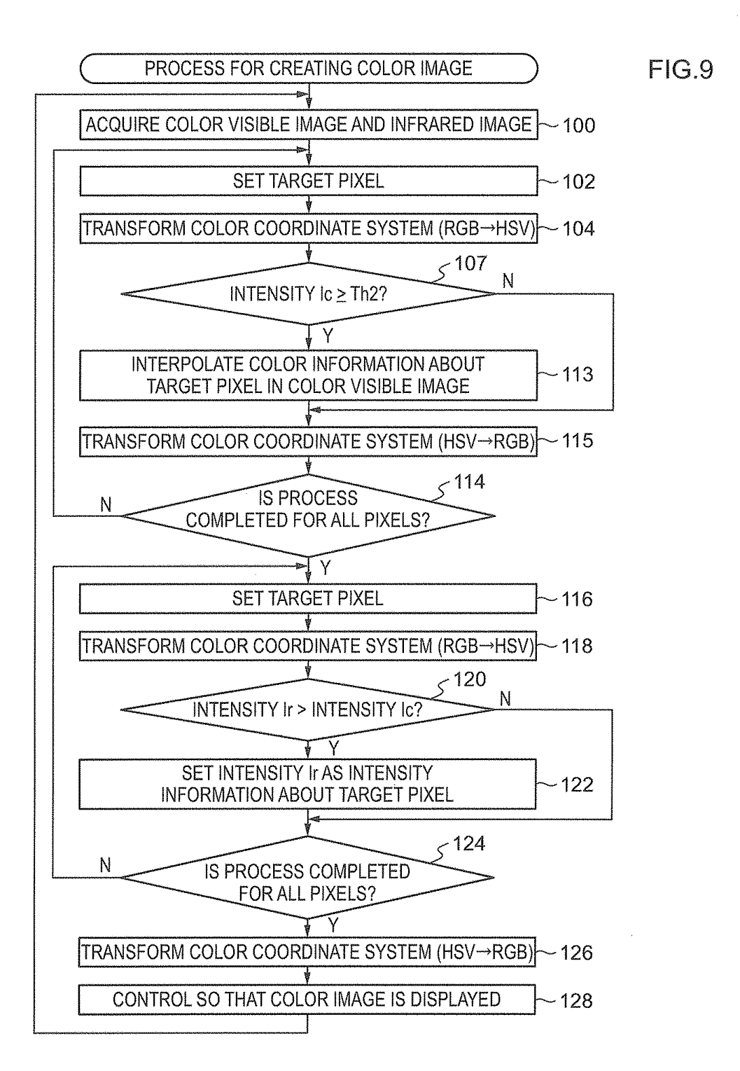

A fourth exemplary embodiment is described below. The description about structures and process similar to those in the first to third exemplary embodiments are occasionally omitted. The identical symbols are given to them, and the description thereof is occasionally omitted. A different point between the second exemplary embodiment and the fourth exemplary embodiment is described. In the second exemplary embodiment, the program for executing the process routine for creating a color image shown in FIG. 5 is stored in the ROM 18a, and the CPU 18c executes the process for creating a color image shown in FIG. 5. On the other hand, a program for executing a process routine for creating a color image shown in FIG. 9 is stored in the ROM 18a, and the CPU 18c retrieves the program for executing the process routine for creating a color image shown in FIG. 9 from the ROM 18a, and executes the process for creating a color image shown in FIG. 9. The fourth exemplary embodiment is different from the second exemplary embodiment in that the process for creating a color image shown in FIG. 9 is executed.

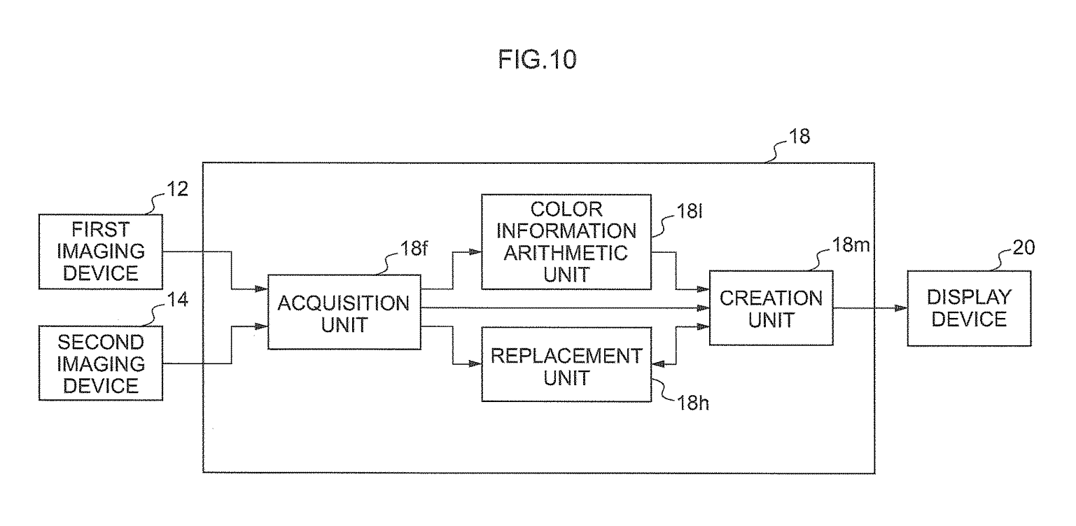

The computer 18 is represented by a functional block according to the process for creating a color image shown in FIG. 9 described in detail below. As shown in FIG. 10, the computer 18 is configured by the acquisition unit 18f, a color information arithmetic unit 181, the replacement unit 18h, and a creation unit 18m.

The color information arithmetic unit 181 interpolates color information for a pixel which is included in a color visible image and which has intensity equal to or higher than the predetermined value using color information for pixels circumjacent to that pixel which have intensity lower than the predetermined value. In such a manner, the color information arithmetic unit 181 calculates color information for the pixel having the intensity equal to or higher than the predetermined value.

The creation unit 18m creates a color image. The calculated color information and the intensity information acquired by the imaging are used for a pixel of the color visible image whose color information is calculated by the color information arithmetic unit 181. The color information and the intensity information that are acquired by the imaging are used for a pixel of the color visible image whose color information is not calculated by the color information arithmetic unit 181.

The process routine for creating a color image shown in FIG. 9 to be executed by the CPU 18c of the computer 18 is described.

Similarly to the third exemplary embodiment, steps 100, 102, 104, and 107 are executed.

When the determination is made at step 107 that the intensity Ic is equal to or higher than the predetermined value Th2, the color information for the target pixel in the color visible image set at step 102 is determined as unsuitable for color display. The sequence goes to step 113.

The pixels circumjacent to the target pixel in the color visible image set at step 102 having intensity lower than the predetermined value Th2 (for example, pixels in a region of 128 pixels by 128 pixels in which the target pixel is set as center) are specified at step 113. The color information for the target pixel in the color visible image set at step 102 is interpolated by using color information for the specified pixels. As a result, the color information for the target pixel in the color visible image having the intensity equal to or higher than the predetermined value Th2 is calculated. As a result, the color information for the target pixel in the color visible image having the intensity equal to or higher than the predetermined value Th2 becomes information suitable for color display. The sequence goes to step 115.

On the other hand, when the determination is made at step 107 that the intensity Ic is lower than the predetermined value Th2, the color information for the target pixel in the color visible image set at step 102 is determined as suitable for color display. The sequence goes to step 115.

When the pixel of the color visible image set as the target pixel at step 102 is a pixel whose color information is calculated at step 113, the image data of the target pixel set at step 102 is transformed from the HSV space to the RGB space at step 115. The color information calculated at step 113 and the intensity information extracted at step 104 (the intensity information acquired by the imaging) are used. When the pixel of the color visible image set as the target pixel at step 102 is a pixel whose color information is not calculated at step 113, the image data about the target pixel set at step 102 is transformed from the HSV space to the RGB space at step 115. The color information and the intensity information that are extracted at step 104 are used. As a result, RGB image data of the pixel in the color visible image set as the target pixel at step 102 may be acquired.

A determination is made at step 114 whether the process at each step (steps 102, 104, 107, 113 when determined as positive at 107, and 115) is completed for all the pixels. When the process is not completed for all the pixels, the sequence returns to step 102, and another pixel which is not subject to the process is set as the target pixel. On the other hand, when the determination is made at step 114 that the process at each step is completed for all the pixels, the sequence goes to step 116.

At steps 102, 104, 107, and 113, the color information for the pixel which is included in the color visible image and which has intensity equal to or higher than the predetermined value Th2 is calculated in the following manner. The color information for the pixel which is included in the color visible image and which has the intensity equal to or higher than the predetermined value Th2 is interpolated by using color information for pixels circumjacent to that pixel which have intensity lower than the predetermined value Th2.

At steps 115 and 114, a color image is created. The calculated color information and the intensity information acquired by the imaging are used for a pixel of the color visible image whose color information is calculated at step 113. The color information and the intensity information that are acquired by the imaging are used for a pixel of the color visible image whose color information is not calculated at step 113.

Since the subsequent steps (steps 116, 118, 120, 122, 124, 126, and 128) are similar to those in the first exemplary embodiment, the description thereof is omitted.

The process for creating a color image according to the fourth exemplary embodiment is described above. The color information arithmetic unit 181 executes steps 102, 104, 107, and 113, and the creation unit 18m executes steps 115, 114, 126, and 128.

In the color image creating apparatus 10 according to the fourth exemplary embodiment, a color image is created in the following manner. The color information for the pixel of the color visible image which is unsuitable for color display (namely, the pixel of the color visible image having the intensity equal to or higher than the predetermined value Th2) is calculated by interpolation using the color information for the pixels of the color visible image which is suitable for color display (namely, the pixels of the color visible image having the intensity lower than the predetermined vale Th2). The calculated color information and the intensity information acquired by the imaging are used for a pixel of the color visible image whose color information is calculated. The color information and the intensity information that are acquired by the imaging are used for a pixel which is included in the color visible image and whose color information is not calculated.

Therefore, images having better visibility may be obtained by using the color image creating apparatus 10 according to the fourth exemplary embodiment.

The fourth exemplary embodiment describes the example where the color image created at steps 102, 104, 107, 113, 115, and 114 is subject to the process at steps 116, 118, 120, 122, and 124 so that another color image is further created to be displayed at steps 126 and 128. However, the invention is not limited to this. For example, the display device 20 may be controlled so as to display the color image created at steps 102, 104, 107, 113, 115, and 114.

### Fifth Exemplary Embodiment

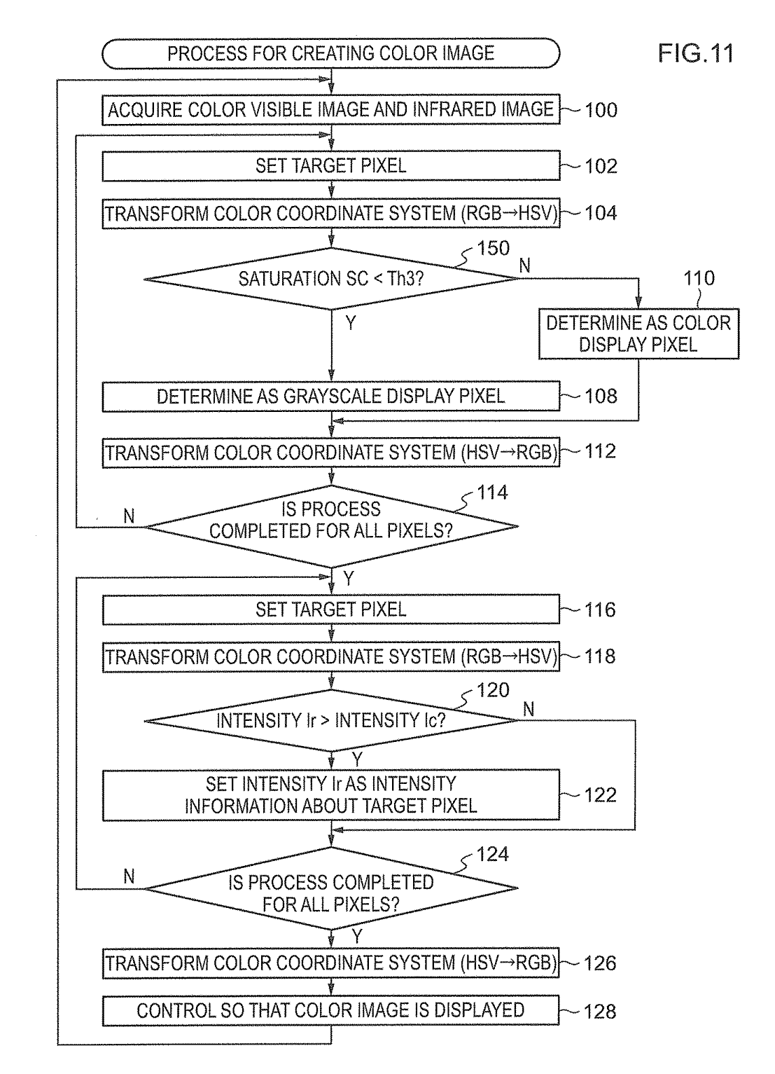

A fifth exemplary embodiment is described below. Description about the similar constitution and process to those in the first to fourth exemplary embodiments are occasionally omitted. The same reference symbols are given to them, and the description thereof is occasionally omitted. A different point between the first and fifth exemplary embodiments is described. In the first exemplary embodiment, the program for executing the process routine for creating a color image shown in FIG. 3 is stored in the ROM 18a, and the CPU 18c executes the process for creating a color image shown in FIG. 3. On the other hand, in the fifth exemplary embodiment, a program for executing a process routine for creating a color images shown in FIG. 11 is stored in the ROM 18a. The CPU 18c retrieves the program for executing the process routine for creating a color image shown in FIG. 11 from the ROM 18a, and executes the process for creating a color image shown in FIG. 11. The fifth exemplary embodiment is different from the first exemplary embodiment in that the process for creating a color image shown in FIG. 11 is executed.

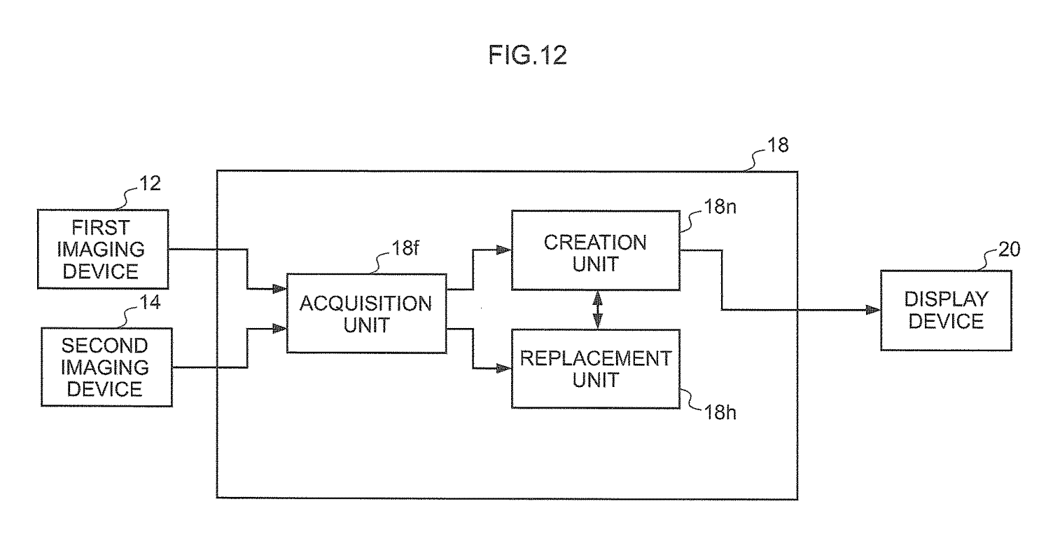

When the computer 18 is represented by a functional block according to the process for creating a color image shown in FIG. 11 described in detail below. As shown in FIG. 12, it is configured by the acquisition unit 18f, a creation unit 18n, and the replacement unit 18h.

The creation unit 18n creates a color image. Intensity information and color information that are acquired by imaging are used for a pixel which is included in a color visible image and which has saturation equal to or higher than a predetermined value so as to effect display in color. The intensity information acquired by the imaging is used for a pixel which is included in the color visible image and which has a lower saturation level than the predetermined value so as to effect display in grayscale.

The process routine for creating a color image shown in FIG. 11 executed by the CPU 18c of the computer 18 is described.

Similarly to the first exemplary embodiment, steps 100, 102, and 104 are executed.

Saturation Sc of the target pixel in the color visible image extracted at step 104 is compared with a predetermined value Th3, and a determination is made at step 150 whether the saturation Sc is lower than the predetermined value Th3 (the saturation Sc is lower than the predetermined value Th3). In the fifth exemplary embodiment, a certain value is experimentally acquired in advance, and the acquired certain value is set as the predetermined value Th3 in advance. This certain value is acquired as follows. When the saturation level is lower than the certain value, the amount of the color information for the pixel is small, and thus the pixel is not suitable for color display (namely, the visibility of a displayed color image is low). When the saturation is equal to or higher than the certain value, the amount of the color information for the pixel is large, and thus the pixel is suitable for color display (namely, the visibility of a displayed color image is high). It is considered that the pixel which has the lower saturation level than the predetermine value Th3 does not include a sufficient amount of information for coloring, and thus forcible coloring becomes unnatural.

When the determination is made at step 150 that the saturation Sc is lower than the predetermined value Th3, the color information for the target pixel in the color visible image set at step 102 is determined as color information unsuitable for color display. The sequence goes to step 108.

Similarly to the first exemplary embodiment, the target pixel in the color visible image set at step 102 is determined as a grayscale display pixel at step 108. The sequence goes to step 112.

On the other hand, when the determination is made at step 150 that the saturation Sc is equal to or higher than the predetermined value Th3, the color information for the target pixel in the color visible image set at step 102 is determined as the color information suitable for color display. The sequence goes to step 110.

Similarly to the first exemplary embodiment, the target pixel in the color visible image set at step 102 is determined as the color display pixel at step 110. The sequence goes to step 112.

Similarly to the first exemplary embodiment, image data of the pixel in the color visible image set as the target pixel at step 102 is transformed from the HSV space to the RGB space at step 112.

The determination is made at step 114 whether the process at each step (108 when determined positive at steps 102, 104, 150, 150, and 110 and 112 when determined as negative at 150) is completed for all the pixels. When the process is not completed for all the pixels, the sequence returns to step 102, and another pixel which is not subject to the process is set as the target pixel. On the other hand, when the determination is made at step 114 that the process is completed for all the pixels, the sequence goes to step 116.

In the process at steps 102, 104, 150, 108, 110, 112, and 114, a color image is created. The intensity information and the color information that are acquired by the imaging are used for a pixel which is included in the color visible image and which has the saturation equal to or higher than the predetermined value Th3 so as to effect display in color. The intensity information acquired by the imaging is used for a pixel which is included in the color visible image and which has the saturation lower than the predetermined value Th3 so as to effect display in grayscale.

Since subsequent steps (steps 116, 118, 120, 122, 124, 126, and 128) are similar to those in the first exemplary embodiment, the description thereof is omitted.

The process for creating a color image according to the fifth exemplary embodiment is described above. The creation unit 18n executes steps 102, 104, 150, 108, 110, 112, 114, 126, and 128.

In the color image creating apparatus 10 according to the fifth exemplary embodiment, a color image is created in the following manner. The intensity information and the color information that are acquired by the imaging are used for the pixel in the color visible image having the color information suitable for the color display (namely, the pixel in the color visible image having the saturation equal to higher than the predetermined value Th3) so as to effect display in color. The intensity acquired by the imaging is used for the pixel in the color visible image having the color information unsuitable for color display (namely, the pixels in the color visible image having the lower saturation level than the predetermined value Th3) so as to effect display in grayscale.

Therefore, images have better visibility may be obtained by using the color image creating apparatus 10 according to the fifth exemplary embodiment.

The fifth exemplary embodiment describes the example where the color image created by the process at steps 102, 104, 150, 108, 110 112, and 114 is subject to the process at steps 116, 118, 120, 122 and 124, and another color image is further created at steps 126 and 128 to be displayed. However, the invention is not limited to this. For example, the display device 20 may be controlled so as to display the color image created at steps 102, 104, 150, 108, 111, 112, and 114.

### Sixth Exemplary Embodiment

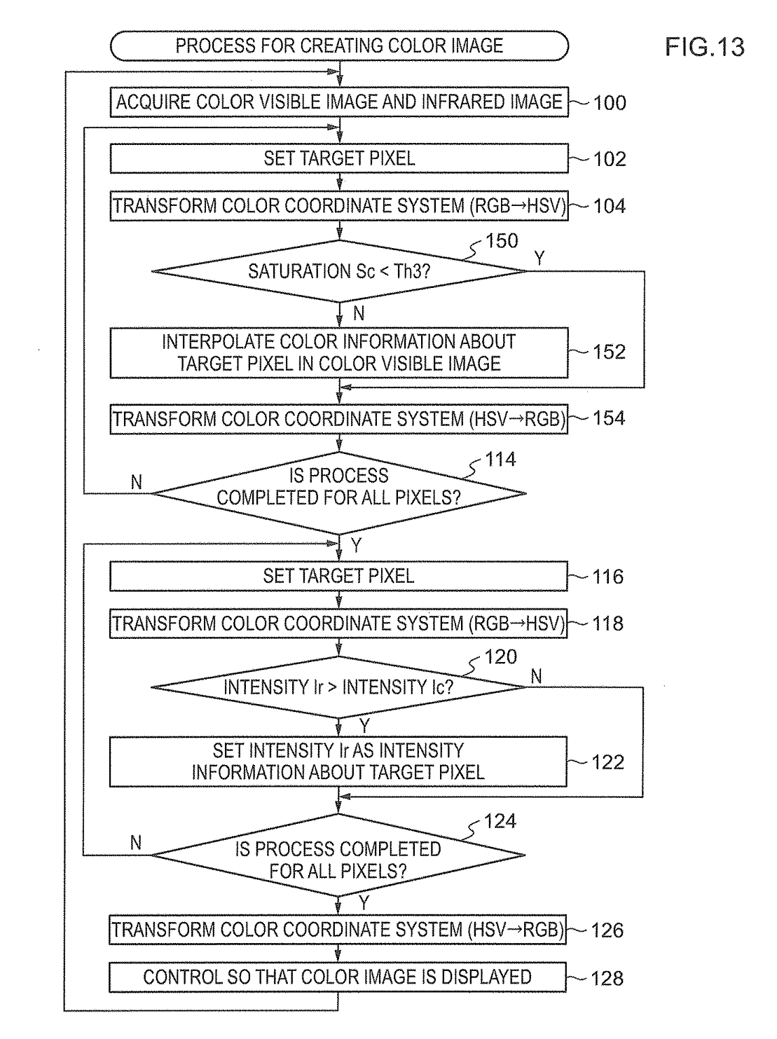

A sixth exemplary embodiment is described below. Description about the similar constitution and process to those in the first to fifth exemplary embodiments is occasionally omitted. The same reference symbols are given to them, and the description thereof is occasionally omitted. A different point between the fifth exemplary embodiment and the sixth exemplary embodiment is described. In the fifth exemplary embodiment, the program for executing the process routine for creating a color image shown in FIG. 11 is stored in the ROM 18a, and the CPU 1 Sc executes the process for creating a color image shown in FIG. 11 On the other hand, in the sixth exemplary embodiment, a program for executing a process routine for creating a color image shown in FIG. 13 is stored in the ROM 18a. The CUP 18c retrieves the program for executing the process routine for creating a color image shown in FIG. 13 from the ROM 18a, and executes the process for creating a color image shown in FIG. 13. The sixth exemplary embodiment is different from the fifth exemplary embodiment in that the process for creating a color image shown in FIG. 13 is executed.

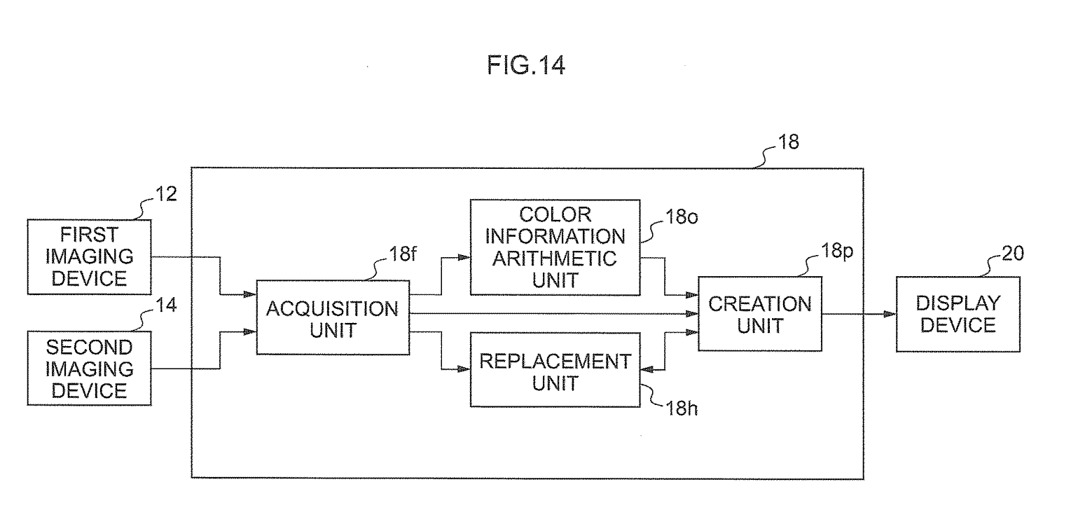

The computer 18 is represented by a functional block according to the process for creating a color image shown in FIG. 13 described in detail below. As shown in FIG. 14, the computer 18 is configured by the acquisition unit 18f, a color information arithmetic unit 18o, the replacement unit 18h, and a creation unit 18p. The color information arithmetic unit 18o interpolates color information for a pixel which is included in a color visible image and which has a lower saturation level than a predetermined value using color information for pixels circumjacent to that pixel which have saturation equal to or higher than the predetermined value. As a result, the color information arithmetic unit 18o calculates the color information for the pixel which is included in the color visible image and which has the lower saturation level than the predetermined value.

The creation unit 18p creates a color images. The calculated color information and the intensity information acquired by the imaging are used for a pixel in the color visible image whose color information is calculated by the color information arithmetic unit 18o. The color information and the intensity information that are acquired by the imaging are used for a pixel in the color visible image whose color information is not calculated by the color information arithmetic unit 18o.

The process routine for creating a color image shown in FIG. 13 to be executed by the CPU 18c of the computer 18 is described below.

Similarly to the fifth exemplary embodiment, steps 100, 102, 104, and 105 are executed.

When the determination is made at step 150 that the saturation Sc level is lower than the predetermined value Th3, the color information for the target pixel in the color visible image set at step 102 is determined as unsuitable for color display. The sequence goes to step 152.

At step 152, pixels circumjacent to the target pixel in the color visible image set at step 102 (for example, pixels in a region of 128 pixels by 128 pixels in which the target pixels is set as center) having the saturation equal to or higher than the predetermined value Th3 are specified. The color information for the target pixel in the color visible image set at step 102 is interpolated by using the color information for the specified pixels. As a result, the color information for the target pixel in the color visible image having the lower saturation level than the predetermined value Th3 is calculated. As a result, the color information for the target pixel in the color visible image having the lower saturation level than the predetermined value Th3 is suitable for color display. The sequence goes to step 154.

On the other hand, when the determination is made at step 150 that the saturation Sc is equal to or higher than the predetermined value Th3, the color information for the target pixel in the color visible image set at step 102 is determined as suitable for color display. The sequence goes to step 154.

When the pixel in the color visible image set as the target pixel at step 102 is a pixel whose color information is calculated at step 152, image data of the target pixel set at step 102 is transformed from the HSV space to the RGB space at step 154 by using the color information calculated at step 152 and the intensity information extracted at step 104 (the intensity information acquired by the imaging). When the pixel in the color visible image set as the target pixel at step 102 is a pixel whose color information is not calculated at step 152, the image data of the target pixel set at step 102 is transformed from the HSV space to the RGB space at step 154 using the color information and the intensity information that are extracted at step 104. As a result, the RGB image data of the pixel in the color visible image set as the target pixel at step 102 may be acquired.

The determination is made at step 114 whether the process at each step (steps 102, 104, 150, 152 when determined as positive at 150, and 154) is completed for all the pixels. When the process is not completed for all the pixels, the sequence returns to step 102, and another pixel which is not subject to the process are set as the target pixel. On the other hand, when the determination is made at step 114 that the process at steps is completed for all the pixels, the sequence goes to step 116.

At steps 102, 104, 150, and 152, the color information for the pixel in the color visible image having the lower saturation level than the predetermined value Th3 is interpolated by using the color information for the pixels circumjacent to that pixel which have the saturation equal to or higher than the predetermined value Th3. As a result, the color information for the pixel having the lower saturation level than the predetermined value Th3 is calculated.

At steps 154 and 114, a color image is created in the following manner. The calculated color information and the intensity information acquired by the imaging are used for a pixel which is included in the color visible image and whose color information is calculated at step 152. The color information and the intensity information that are acquired by the imaging are used for a pixel which is included in the color visible image and whose color information is not calculated at step 152.

Since subsequent steps (steps 116, 118, 120, 122, 124, 126, and 128) are similar to those in the first exemplary embodiment, the description thereof is omitted.

The process for creating a color image according to the sixth exemplary embodiment is described above. Steps 102, 104, 150, and 152 are executed by the color information arithmetic unit 18o, and steps 154, 114, 126, and 128 are executed by the creation unit 18p.

The color image creating apparatus 10 according to the sixth exemplary embodiment creates a color image in the following manner. The color information for the pixel in the color visible image (namely, the pixel in the color visible image having the lower saturation level than the predetermined value Th3) which is unsuitable for color display is calculated by interpolation using the color information for the pixels in the color visible image (namely, the pixels in the color visible image having the saturation equal to or higher than the predetermined value Th3) which is suitable for color display. The color images are created in the following manner. The calculated color information and the intensity information acquired by the imaging are used for a pixel which is included in the color visible image and whose color information is calculated at step 152. The color information and the intensity information that are acquired by the imaging are used for the pixel which is included in the color visible image and whose color information is not calculated at step 152.

Therefore, images having better visibility may be obtained by using the color image creating apparatus 10 according to the sixth exemplary embodiment.

The sixth exemplary embodiment describes the example where the color image created at steps 102, 104, 150, 152 154, and 114 is subject to the process at steps 116, 118, 120, 122, and 124, and another color image is further created to be displayed at steps 126 and 128. However, the invention is not limited to this. For example, the display device 20 may be controlled so as to display the color image created at steps 102, 104, 150, 152, 154, and 114.

### Seventh Exemplary Embodiment

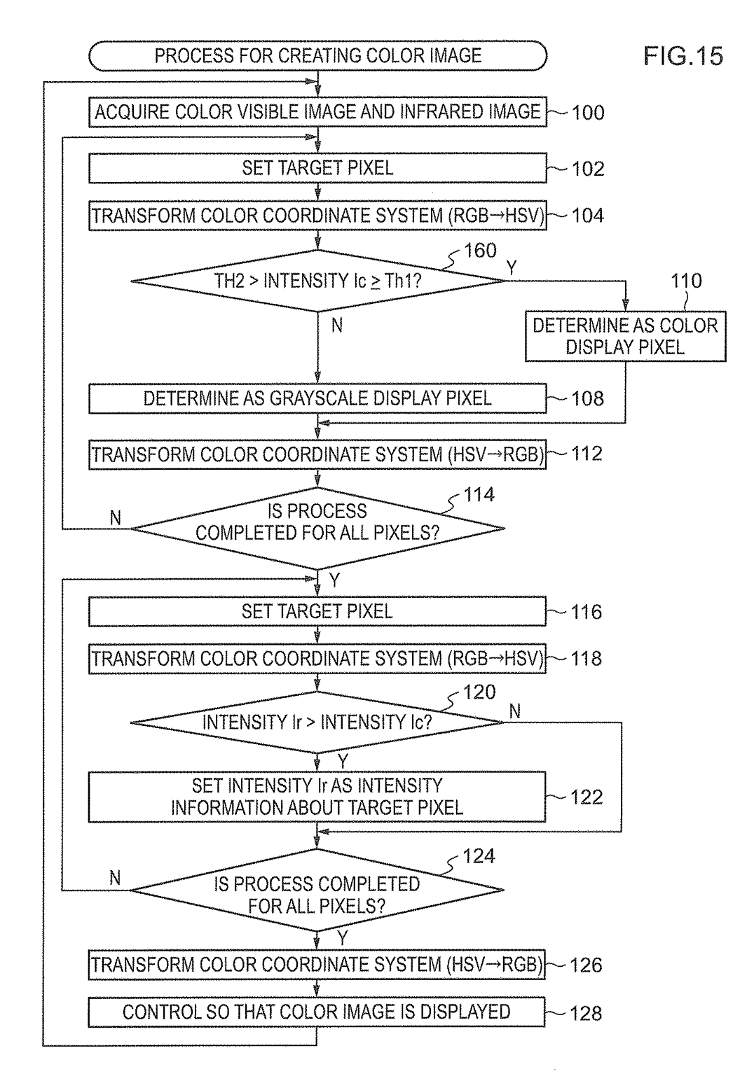

A seventh exemplary embodiment is described below. Description about the similar constitution and process to those in the first to sixth exemplary embodiments is occasionally omitted. The same reference symbols are given to them, and the description thereof is occasionally omitted. A different point between the first exemplary embodiment and the seventh exemplary embodiment is described. In the first exemplary embodiment, the program for executing the process routine for creating a color image shown in FIG. 3 is stored in the ROM 18a, and the CPU 18c executes the process for creating a color image shown in FIG. 3. On the other hand, in the seventh exemplary embodiment, a program for executing a process routine for creating a color image shown in FIG. 15 is stored in the ROM 18a. The CPU 18c retrieves the program for executing the process routine for creating a color image shown in FIG. 15 from the ROM 18a, and executes the process for creating a color image shown in FIG. 15. The seventh exemplary embodiment is different from the first exemplary embodiment in that the process for creating a color image shown in FIG. 15 is executed.

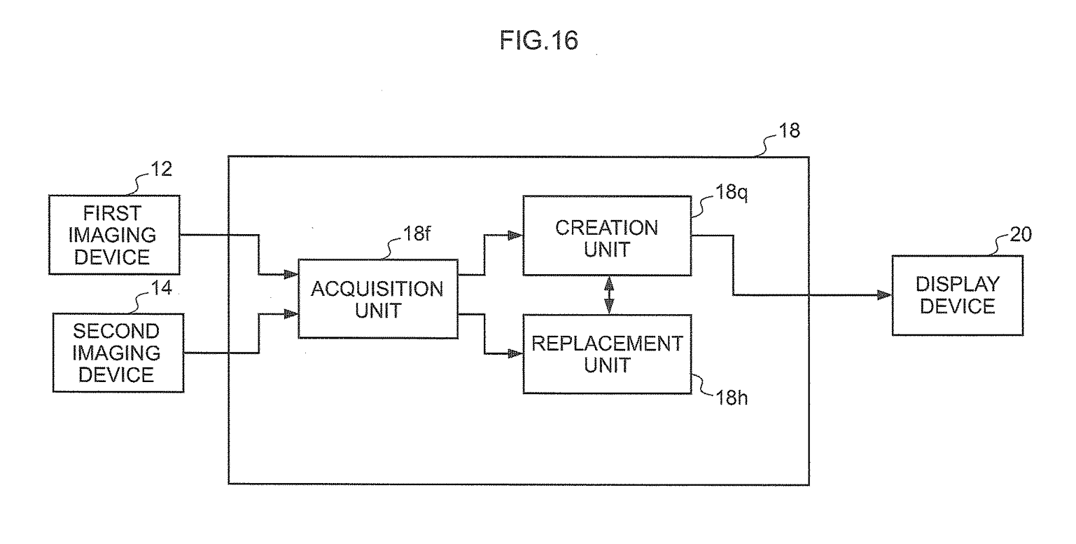

The computer 18 is represented by a functional block according to the process for creating a color image shown in FIG. 15 described in detail below. As shown in FIG. 16, the computer 18 is configured by the acquisition unit 18f, a creation unit 18q, and the replacement unit 18h.

The creation unit 18q creates a color image in the following manner. Intensity information and color information that are acquired by imaging are used for a pixel which is included in a color visible image and which has intensity equal to or higher than a first predetermined value and lower than a second predetermined value which is higher than the first predetermined value so as to effect display in color. The intensity information acquired by the imaging is used for a pixel which is included in the color visible image and which has intensity lower than the first predetermined value and equal to or higher than the second predetermined value so as to effect display in grayscale.

A process routine for creating a color image shown in FIG. 15 to be executed by the CPU 18c of the computer 18 is described.

Similarly to the first exemplary embodiment, steps 100, 102, and 104 are executed. The sequence goes to step 160. The intensity Ic of the target pixel in the color visible image extracted at step 104 is compared with the predetermined value Th1 (first predetermined value) and the predetermined value Th2 (second predetermined value). A determination is then made at step 160 whether the intensity Ic is equal to or higher than the predetermined value Th1 and lower than the predetermined value Th2. The predetermined value Th2 is larger than the predetermined value Th1.

When the determination is made at step 160 that the intensity Ic is equal to or higher than the predetermined value Th1 and lower than the predetermined value Th2, the sequence goes to step 110. On the other hand, when the determination is made at step 160 that the intensity Ic is lower than the predetermined value Th1 or intensity Ic is equal to or higher than the predetermined value Th2, the sequence goes to step 108.

Similarly to the first exemplary embodiment, the target pixel in the color visible image set at step 102 is determined as a grayscale display pixel at step 108. The sequence goes to step 112.

The target pixel in the color visible image set at step 102 is determined as a color display pixel at step 110. The sequence goes to step 112.

Similarly to the first exemplary embodiment, image data of the pixel in the color visible image set as the target pixels at step 102 is transformed from the HSV space to the RGB space at step 112.

A determination is made at next step 114 whether the process at each step (steps 102, 104, 160, and 110 when determined as positive at 160, and 108 and 112 when determined as negative at 160) is completed for all the pixels. When the process is not completed for all the pixels, the sequence returns to step 102, and another pixel which is not subject to the process are set as the target pixel. On the other hand, when the determination is made at step 114 that the process at each step is completed for all the pixels, the sequence goes to step 116.

In the process at steps 102, 104, 160, 108, 110, 112, and 114, a color image is created. The intensity information and the color information that are acquired by the imaging are used for a pixel which is included in the color visible image and which has the intensity equal to or higher than the predetermined value Th1 and lower than the predetermined value Th2 which is larger than the first predetermined value so as to effect display in color. The intensity information acquired by the imaging is used for a pixel which is included in the color visible image and which has the intensity lower than the first predetermined value Th1 or intensity equal to or higher than the predetermined value Th2 so as to effect display in grayscale.

Since subsequent steps (steps 116, 118, 120, 122, 124, 126, and 128) are similar to those in the first exemplary embodiment, the description thereof is omitted.

The process for creating a color image according to the seventh exemplary embodiment is described above. Steps 102, 104, 160, 108, 110, 112, 114, 126, and 128 are executed by the creation unit 18q.

The color image creating apparatus 10 according to the seventh exemplary embodiment creates a color image. The intensity information and the color information that are acquired by the imaging are used for a pixel in the color visible image which is suitable for color display (namely, the pixel in the color visible image having the intensity equal to or higher than the first predetermined value Th1 and lower than the second predetermined value Th2) so as to effect display in color. The intensity information acquired by the imaging is used for the pixel in the color visible image which is unsuitable for color display (namely, the pixel in the color visible image having the intensity lower than the first predetermined value Th1 or intensity equal to or higher than the second predetermined value Th2) so as to effect display in grayscale.

Therefore, images having better visibility may be obtained by using the color image creating apparatus 10 according to the seventh exemplary embodiment.

The seventh exemplary embodiment describes the example where the color image created at steps 102, 104, 160, 108, 110, 112, and 114 is subject to the process at steps 116, 118, 120, 122, and 124, and another color image is further created to be displayed at steps 126 and 128. However, the invention is not limited to this. For example, the display device 20 may be controlled so as to display the color image created at steps 102, 104, 160, 108, 110, 112, and 114.

### Eighth Exemplary Embodiment

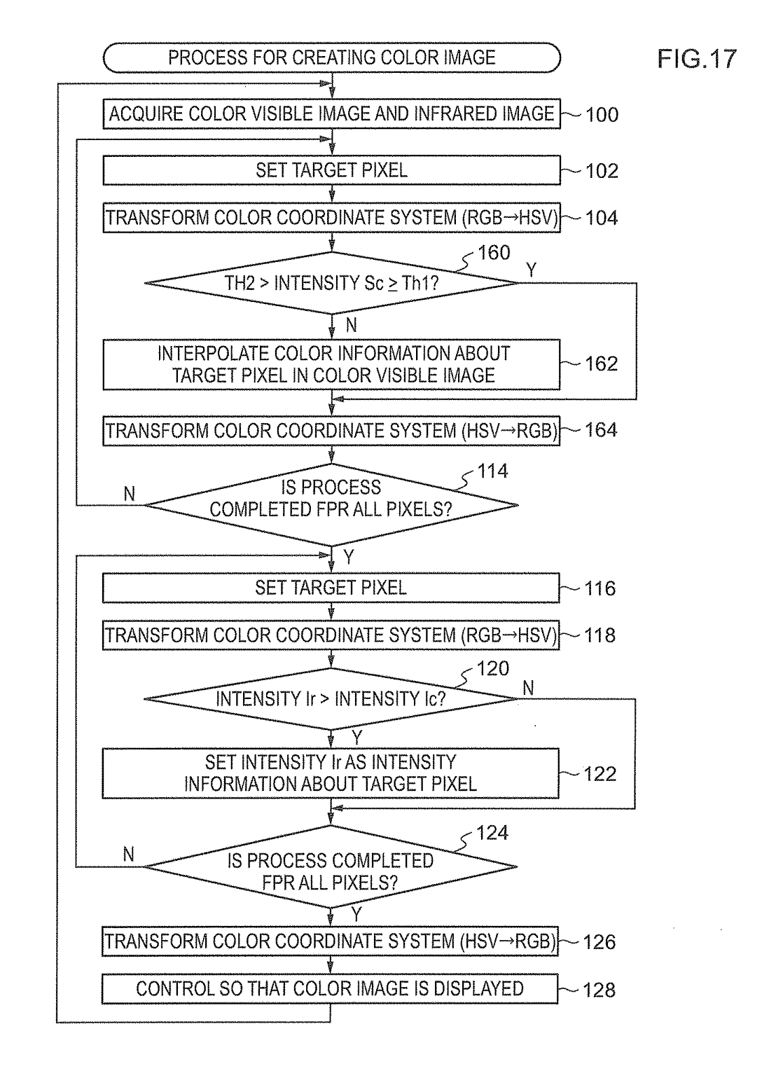

An eighth exemplary embodiment is described below. Description about the similar structure and process to those in the first to seventh exemplary embodiments is occasionally omitted. The same reference symbols are given to them, and the description thereof is occasionally omitted. A different point between the seventh exemplary embodiment and the eighth exemplary embodiment is described. In the seventh exemplary embodiment, the CPU 18c executes the process for creating a color image shown in FIG. 15. On the other hand, in the eighth exemplary embodiment, a program for executing a process routine for creating a color image shown in FIG. 17 is stored in the ROM 18a. The CUP 18c retrieves the program for executing the process routine for creating a color image shown in FIG. 17 from the ROM 18a, and executes the process for creating a color image shown in FIG. 17. The eighth exemplary embodiment is different from the seventh exemplary embodiment in that the process for creating a color image shown in FIG. 17 is executed.

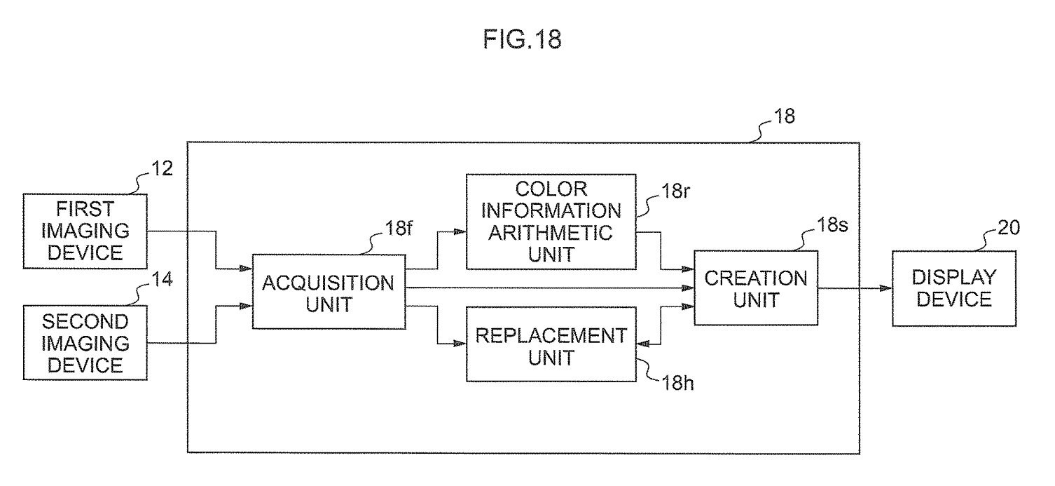

The computer 18 is represented by a functional block according to the process for creating a color image shown in FIG. 17 described in detail below. As shown in FIG. 18, the computer 18 is configured by the acquisition unit 18f, a color information arithmetic unit 18r, the replacement unit 18h, and a creation unit 18s.

The color information arithmetic unit 18r interpolates color information for a pixel which is included in a color visible image and which has intensity lower than the first predetermined value or intensity equal to or higher than the second predetermined value which is larger than the first predetermined value using color information for pixels circumjacent to that pixel which have intensity equal to or higher than the first predetermined value and lower than the second predetermined value. The color information arithmetic unit 18r then calculates the color information for the pixel which is included in the color visible image and which has the intensity lower than the first predetermined value or intensity equal to or higher than the second predetermined value.

The creation unit 18s creates a color image. The calculated color information and the intensity information acquired by the imaging are used for the pixel which is included in the color visible image whose color information is calculated by the color information arithmetic unit 18r. The color information and the intensity information that are acquired by the imaging are used for a pixel which is included in the color visible image and whose color image is not calculated by the color information arithmetic unit 18r.

The process routine for creating a color image shown in FIG. 17 to be executed by the CPU 18c of the computer 18 is described.

Similarly to the seventh exemplary embodiment, steps 100, 102, 104, and 160 are executed. When the determination is made as negative at step 160 (when the determination is made that the intensity Ic is lower than the predetermined value Th1 or intensity Ic is equal to or higher than the predetermined value Th2), the sequence goes to step 162. On the other hand, the determination is made as positive at step 160 (the intensity Ic is equal to or higher than the predetermined value Th1 and lower than the predetermined value Th2), the sequence goes to step 164.

Pixels which have intensity equal to higher than the predetermined value Th1 and lower than the predetermined value Th2 and which are circumjacent to the target pixel in the color visible image set at step 102 (for example, the pixels in a region of 128 pixels by 128 pixels in which the target pixel is set as center) are specified at step 162. The color information for the target pixel in the color visible image set at step 102 is interpolated by using the color information for the specified pixels so that the color information for the target pixel in the color visible image having intensity lower than the predetermined value Th1 or intensity equal to or higher than the predetermined value Th2 is calculated. As a result, the color information for the target pixel in the color visible image having intensity lower than the predetermined value Th1 or intensity equal to or higher than the predetermined value Th2 becomes suitable for color display. The sequence goes to step 164.

When the pixel of the color visible image set as the target pixel at step 102 is the pixel whose color information is calculated at step 162, image data of the target pixel set at step 102 is transformed from the HSV space to the RGB space at step 164 by using the color information calculated at step 162 and the intensity information extracted at step 104 (the intensity information acquired by the imaging). When the pixel of the color visible image set as the target pixel at step 102 is a pixel whose color information is not calculated at step 162, the image data of the target pixel set at step 102 is transformed from the HSV space to the RGB space at step 164 by using the color information and the intensity information that are extracted at step 104. As a result, RGB image data of the pixel in the color visible image set as the target pixel at step 102 may be acquired.

The determination is made at step 114 whether the process at each step (steps 102, 104, 160, 162 when determined as negative at 160, and 164) is completed for all the pixels. When the process is not completed for all the pixels, the sequence returns to step 102, and another pixel which is not subject to the process is set as the target pixel. On the other hand, when the determination is made at step 114 that the process is completed for all the pixels, the sequence goes to step 116.

In the process at steps 102, 104, 160, and 162, the color information for the pixel which is included in the color visible image and which has the intensity lower than the first predetermined value Th1 and equal to or higher than the second predetermined value which is larger than the first predetermined value is interpolated by using the color information for the pixels circumjacent to that pixel which have the intensity equal to or higher than the first predetermined value and lower than the second predetermined value Th2. As a result, the color information for the pixel which is included in the color visible image and which has the intensity lower than the first predetermined value Th1 or intensity equal to or higher than the second predetermined value Th2 is calculated.

In the process at steps 164 and 114, a color visible image is created. The calculated color information and the intensity information acquired by the imaging are used for the pixel which is included in the color visible image and whose color information is calculated at step 162. The color information and the intensity information that are acquired by the imaging are used for the pixel which is included in the color visible image and whose color information is not calculated at step 162.

Since subsequent steps (steps 116, 118, 120, 122, 124, 126, and 128) are similar to those in the first exemplary embodiment, the description thereof is omitted.

The process for creating a color image according to the eighth exemplary embodiment is described above. Steps 102, 104, 160, and 162 are executed by the color information arithmetic unit 18r, and steps 162, 164, 126, and 128 are executed by the creation unit 18s.

The color image creating apparatus 10 according to the eighth exemplary embodiment creates a color image in the following manner. The color information for the pixel in the color visible image unsuitable for color display (namely, the pixel in the color visible image having intensity lower than the first predetermined value Th1 or intensity equal to or higher than the second predetermined value Th2) is calculated by the interpolation using the color information for the pixel in the color visible image suitable for color display (namely, the pixel in the color visible image having the intensity equal to or higher than the predetermined value Th1 and lower than the second predetermined value Th2). The calculated color information and the intensity information acquired by the imaging are used for the pixel in the color visible image whose color information is calculated at step 162. The color information and the intensity information that are acquired by the imaging are used for the pixel in the color visible image whose color information is not calculated at step 162.

Therefore, images having better visibility may be obtained by using the color image creating apparatus 10 according to the eighth exemplary embodiment.

The eighth exemplary embodiment describes the example where the color image created at steps 102, 104, 160, 162, 164, and 114 is subject to the process at steps 116, 118, 120, 122, and 124, and another color image is further created to be displayed at steps 126 and 128. However, the invention is not limited to this. For example, the display device 20 may be controlled so as to display the color image created at steps 102, 104, 160, 162, 164, and 114.

### Ninth Exemplary Embodiment

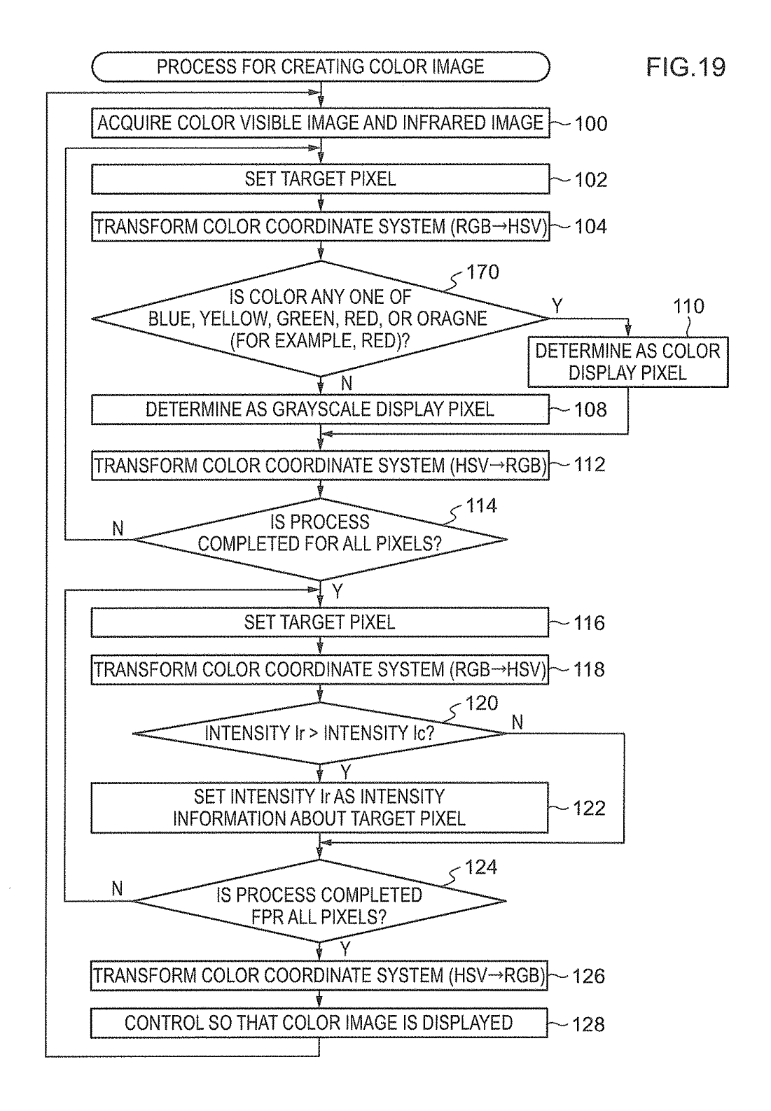

A ninth exemplary embodiment is described below. Description about the similar structure and process to those in the first to eighth exemplary embodiments is occasionally omitted. The same reference symbols are given to them, and the description thereof is occasionally omitted. A different point between the first exemplary embodiment and the ninth exemplary embodiment is described. In the first exemplary embodiment, the CPU 18c executes the process for creating a color image shown in FIG. 3. On the other hand, in the ninth exemplary embodiment, a program for executing a process routine for creating a color image shown in FIG. 19 is stored in the ROM 18a. The CUP 18c retrieves the program for executing the process routine for creating a color image shown in FIG. 19 from the ROM 18a, and executes the process for creating a color image shown in FIG. 19. The ninth exemplary embodiment is different from the first exemplary embodiment in that the process for creating a color image shown in FIG. 19 is executed.

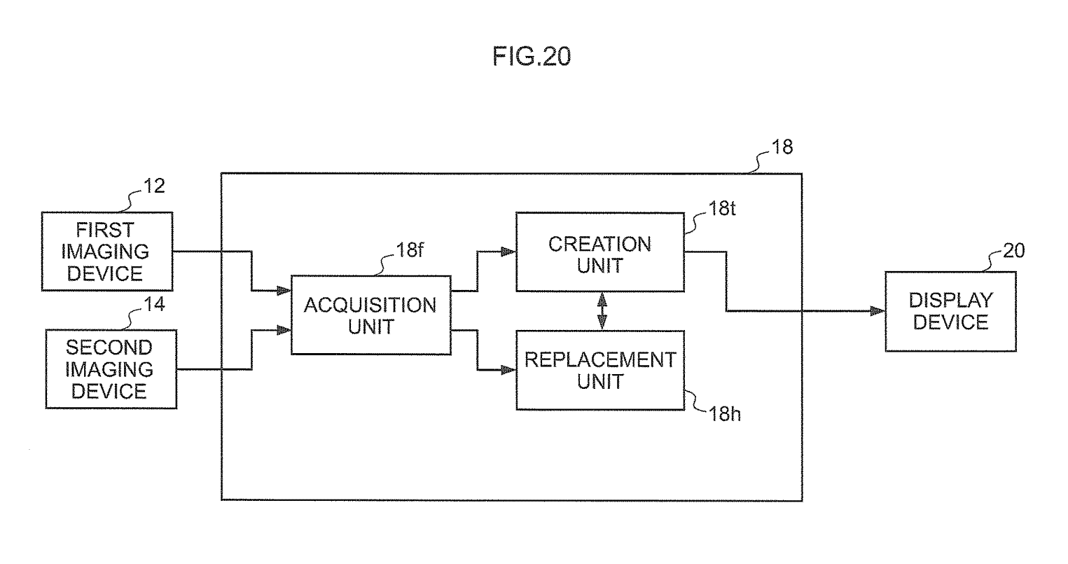

The computer 18 is represented by a functional block according to the process for creating a color image shown in FIG. 19 described in detail below. As shown in FIG. 20, the computer 18 is configured by the acquisition unit 18f, a creation unit 18t, and the replacement unit 18h.

The creation unit 18t creates a color image. Intensity information and color information that are acquired by imaging are used for a pixel which is included in a color visible image and which has color information representing at least one of blue, yellow, green, red, or orange so as to effect display in color. The intensity information acquired by the imaging is used for a pixel which is included in the color visible image and which has color information representing a color other than at least one color of the above-mentioned colors so as to effect display in grayscale.

The process routine for creating a color image shown in FIG. 19 to be executed by the CPU 18c of the computer 18 is described.

Similarly to the first exemplary embodiment, steps 100, 102, and 104 are executed. Sequence goes to step 170. When a determination is made at step 170 whether the color represented by the color information thr the target pixel in the color visible image extracted at step 104 is at least one of blue, yellow, green, red, or orange (for example, red). Blue, yellow, green, red, and orange are, for example, a color of signal lamps, a color of signs, a color of tail lamps, and a color of street light to which an attention should be paid particularly at night. In these colors, red is considered to be the color to which the attention should be paid most, and red is the color of signal lamps, the color of signs, and the color of tail lamps. The color to be used for the determination at step 170 may be “at least one color of blue, yellow, green, red, or orange”, and for example, various combinations such as “red color”, “red color and green color” and “green color and orange color” may be considered.

When the determination is made as positive at step 170 (the color represented by the color information for the target pixel in the color visible image extracted at step 104 is determined as at least one of blue, yellow, green, red, or orange), the sequence goes to step 110. On the other hand, when the determination is made as negative at step 170 (the color represented by the color information for the target pixel in the color visible image extracted at step 104 is not at least one of the above-mentioned colors), the sequence goes to step 108. The case where “the determination is made that the color is not at least one of the above-mentioned colors” means that when the color used for the determination at step 170 is “red”, the color is determined as a color other than red.

The determination is made at step 108 that the target pixel in the color visible image set at step 102 are determined as the grayscale display pixel. The sequence then goes to step 112.

The target pixel in the color visible image set at step 102 is determined as the color display pixel at step 110. The sequence then goes to step 112.

Similarly to the first exemplary embodiment, image data of the pixel in the color visible image set as the target pixel at step 102 is transformed from the HSV space to the RGB space at step 112.

A determination is made at step 114 whether the process at steps (steps 102, 104, 170, 110 when determined as positive at 170, 108 when determined as negative at step 170, and 112) is completed for all the pixels. When the process is not completed for all the pixels, the sequence returns to step 102, and another pixel which is not subject to the process is set as the target pixel. On the other hand, the determination is made at step 114 that the process at steps is completed for all the pixels, the sequence goes to step 116.

At steps 102, 104, 170, 108, 110, 112, and 114, a color image is created in the following manner. The intensity information and the color information that are acquired by the imaging are used for the pixel which is included in the color visible image and which has the color information representing at least one of blue, yellow, green, red, or orange so as to effect display in color. The intensity information acquired by the imaging is used for the pixel in the color visible image having the color information representing a color other than the at least one of the above-mentioned colors so as to effect display in grayscale.

Since subsequent steps (steps 116, 118, 120, 122, 124, 126, and 128) are similar to those in the first exemplary embodiment, the description thereof is omitted.

The process for creating a color image according to the ninth exemplary embodiment is described above. Steps 102, 104, 170, 108, 110, 112, 114, 126, and 128 are executed by the creation unit 18t.

In the color image creating apparatus 10 according to the ninth exemplary embodiment, a color image is created in the following manner. The intensity information and the color information that are acquired by the imaging are used for the pixel in the color visible image having the color information which represents the color of signal lamps, the color of signs, the color of tail lamps, and the color of street light (these colors include blue, yellow, green, red, or orange) to which a driver of a vehicle should pay an attention particularly at night (namely, the pixel having the color information which represents at least one of blue, yellow green, red, or orange) so as to effect display in color. The intensity information acquired by the imaging is used for the pixel having the color information which represents a color to which the driver of the vehicle does not have to pay a special attention (namely, the pixel having color information which represents a color other than the at least one of the above-mentioned colors) so as to effect display in grayscale.

Therefore, images having better visibility may be obtained by using the color image creating apparatus 10 according to the ninth exemplary embodiment.

The ninth exemplary embodiment describes the example where the color image created at steps 102, 104, 170, 108, 110, 112, and 114 is subject to the process at steps 116, 118, 120, 122, and 124, and another color image is further created to be displayed at steps 126 and 128. However, the invention is not limited to this. For example, the display device 20 may be controlled so as to display the color image created at steps 102, 104, 170, 108, 110, 112, and 114.

### Tenth Exemplary Embodiment

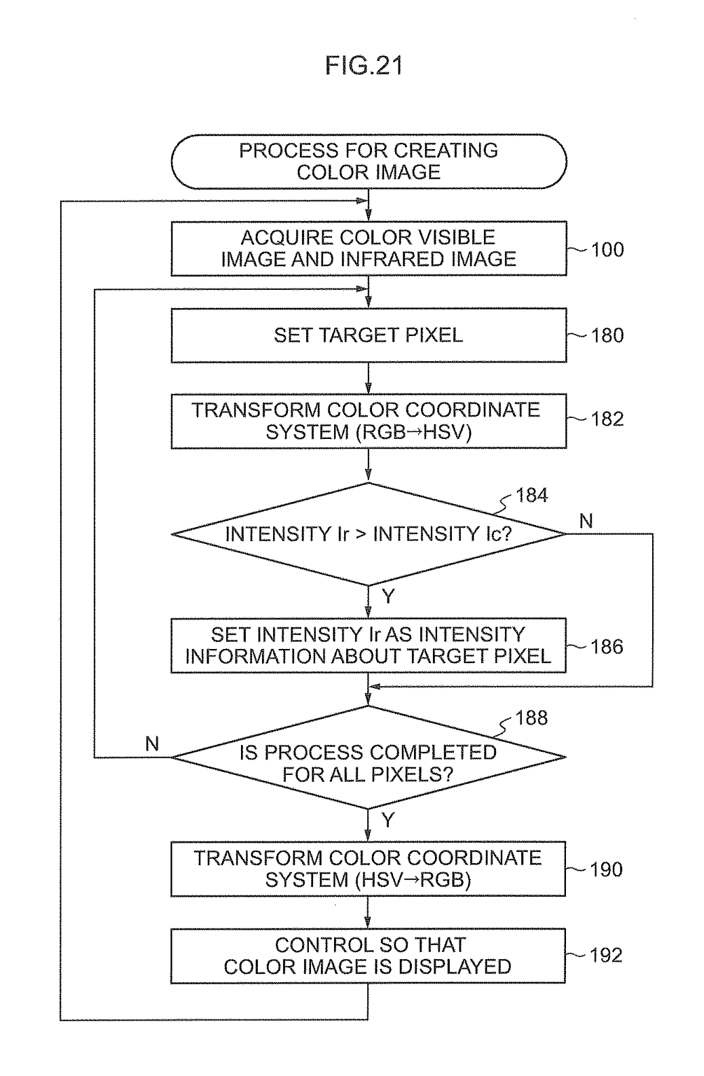

A tenth exemplary embodiment is described below. Description about the similar structure and process to those in the first to ninth exemplary embodiments is occasionally omitted. The same reference symbols are given to them, and the description thereof is occasionally omitted. A different point between the first exemplary embodiment and the tenth exemplary embodiment is described. In the first exemplary embodiment, the CPU 18c executes the process for creating a color image shown in FIG. 3. On the other hand, in the tenth exemplary embodiment, a program for executing a process routine for creating a color image shown in FIG. 21 is stored in the ROM 18a. The CUP 18c retrieves the program for executing the process routine for creating a color image shown in FIG. 21 from the ROM 18a, and executes the process for creating a color image shown in FIG. 21. The tenth exemplary embodiment is different from the first exemplary embodiment in that the process for creating color image shown in FIG. 21 is executed.

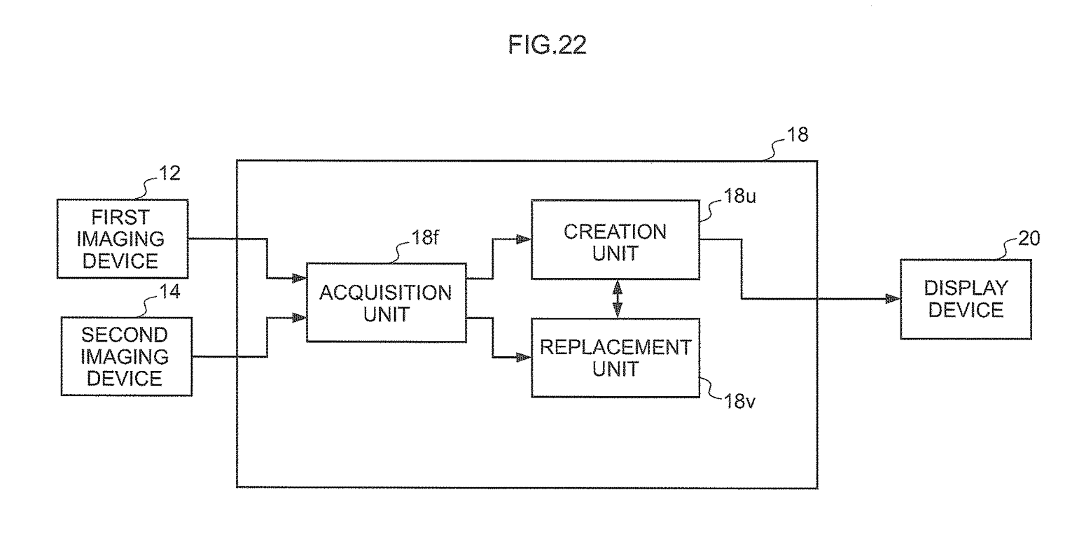

The computer 18 is represented by a functional block according to the process for creating a color image shown in FIG. 21 described in detail below. As shown in FIG. 22, the computer 18 is configured by the acquisition unit 18f, a creation unit 18u, and a replacement unit 18v.

The replacement unit 18v replaces intensity of a pixel which is included in a color visible image acquired by the acquisition unit 18f which has intensity lower than intensity of a corresponding pixel in an infrared image by the intensity of the corresponding pixel.

The creation unit 18u creates a color image in the following manner. The intensity information which represents the intensity after replacement and color information acquired by imaging are used for the pixel in the color visible image whose intensity is replaced by the replacement unit 18v. The intensity information and the color information that are acquired by the imaging are used for a pixel in the color visible image whose intensity is not replaced by the replacement unit 18v.

The process routine for creating a color image shown in FIG. 21 to be executed by the CPU 18c of the computer 18 is described.

Similarly to the first exemplary embodiment, step 100 is executed. The sequence goes to step 180. A pixel of the color visible image and the infrared image acquired at step 100 in corresponding positions is set as the target pixel at step 180. The pixel set as the target pixel at step 180 is not processed at step 182 and later steps described in detail below. The target pixel in the infrared image which corresponds to the target pixel in the color visible image are called a corresponding pixel.

Image data of the pixel in the color visible image set as the target pixel at step 180 is transformed from the RGB space to the HSV space at step 182. The color information (saturation and hue) and the intensity information (value (brightness), namely the information representing the intensity) about the pixel in the color visible image set as the target pixel at step 180 are extracted.

The intensity Ic of the target pixel in the color visible image set at step 180 is compared with the intensity Ir of the target pixel in the infrared image set at step 180, and a determination is made whether the intensity Ic is lower than the intensity Ir at step 184.

When the determination is made at step 184 that the intensity Ic is lower than the intensity Ir, the sequence goes to step 186. On the other hand, when the determination is made at step 184 that the intensity Ic is equal to or higher than the intensity Ir, the sequence goes to step 188.

The intensity Ic of the target pixels in the color visible image is set as the intensity Ir of the infrared image so that the intensity Ic is replaced by the intensity Ir at step 186. The sequence then goes to step 188.

A determination is made at step 188 whether process at steps (steps 180, 182, 184, and 186 when determined as positive at 184) is completed for all the pixels. When the process is not completed for all the pixels, the sequence returns to step 180, and another pixel which is not processed is set as the target pixel. On the other hand, when the determination is made at step 188 that the process at steps is completed for all the pixels, the sequence goes to step 190.

In the process at steps 180, 182, 184, 186, and 188, the intensity Ic of the pixel in the color visible image acquired at step 100, that is lower than the intensity Ir of the corresponding pixel in the infrared image, is replaced by the intensity Ir of the corresponding pixel.

Image data of the plural pixel included in the color visible image is transformed from the HSV space to the RGB space at step 190. As a result, the RGB image data of the pixel in the color visible image may be acquired. At the time of the transformation from the HSV space to the RGB space, the intensity replaced at step 186 and the color information extracted at step 182 (the color information acquired by the imaging) are used for the pixel whose intensity is replaced at step 186 among the plural pixels included in the color visible image. At the time of the transformation from the HSV space to the RGB space, the intensity extracted at step 182 (the intensity information representing the intensity) and the color information extracted at step 182 are used for the pixel whose intensity is not replaced at step 186 among plural pixels included in the color visible image.

At step 192, the display device 20 is controlled so as to display the created color images using the RGB image data acquired at step 190. The sequence then returns to step 100.

As described above, in the process at steps 190 and 192, a color image is created in the following manner. The intensity information representing the intensity after replacement and the color information acquired by the imaging are used for the pixel of the color visible image whose intensity is replaced at step 186. The intensity information and the color information that are acquired by the imaging are used for the pixel in the color visible image whose intensity is not replaced at step 186.

The process for creating a color image according to the tenth exemplary embodiment is described above. Steps 180, 182, 184, 186, and 188 are executed by the replacement unit 18v, and steps 190 and 192 are executed by the creation unit 18u.

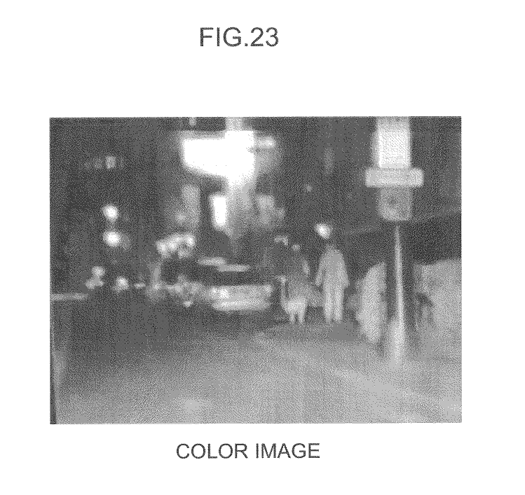

The color image creating apparatus 10 according to the tenth exemplary embodiment creates a color image in the following manner. The intensity Ic of the pixel in the color visible image is compared with the intensity Ir of the corresponding pixel in the infrared image. The intensity Ic of the pixel in the color visible image which is lower than the intensity Ir of the corresponding pixels in the infrared image is replaced by intensity which makes the visibility better. For example, the color image shown in FIG. 23 is displayed on the display device 20.

Therefore, images having better visibility may be obtained by using the color image creating apparatus 10 according to the tenth exemplary embodiment.

The tenth exemplary embodiment, in the process at steps 180, 182, 184, 186, and 188 describes the example where the intensity Ic of the pixel in the color visible image which is lower than the intensity Ir of the corresponding pixel in the infrared image is replaced by the intensity Ir of the corresponding pixel. However, the invention is not limited to this. For example, the intensity Ic of the pixel which is included in the color visible image and which has intensity lower than the intensity Ir of the corresponding pixel in the infrared image may be replaced by a weighted mean of the intensity Ic and the intensity Ir. In this case, the pixels in both the images are weighted in a predetermined manner. As a result, when the intensity Ir is saturated, the saturation of the intensity may be repressed.

The first to tenth exemplary embodiment describes the example where intensity or saturation is compared or determined per pixel unit. However, the invention is not limited to this, and an area including plural pixels may form a unit for comparison or determination. In this case, for example, average intensity or average saturation of the respective blocks may be used for the comparison or determination.

The case where a color image is displayed by using a color visible image and an infrared image is described as the example, but the invention is not limited to this. A color image may be displayed by using a color visible image and a far-infrared image. In this case, a far-infrared image is created by using a far-infrared camera, or a scene ahead of the vehicle may be imaged by using a far-infrared filter that allows a waveband of far-infrared light to pass through. The scene ahead of the vehicle may be imaged without using an infrared light source.

The example where the acquisition unit, the creation unit, the color information arithmetic unit, and the replacement unit are realized by the computer is described above. However, the invention is not limited to this, and the acquisition unit, the creation unit, the color information arithmetic unit, and the replacement unit may be configured of plural computers or one or plural electronic circuits) for realizing the functions of the respective units.

The programs in the respective exemplary embodiments of the invention may be stored in a storage medium so as to be provided.

According to a first aspect of the invention, there is provided a color image creating apparatus that includes: an acquisition unit which acquires a color visible image from an imaging unit which images the color visible image based on light in a visible light range, the color visible image including a plurality of pixels which each include color information and intensity information; and a creation unit which uses the intensity information acquired by the imaging and the color information acquired by the imaging for a pixel included in the color visible image which has intensity equal to or higher than a predetermined value so as to effect display in color, and uses the intensity information acquired by the imaging for a pixel included in the color visible image which has lower intensity than the predetermined value so as to effect display in grayscale, and creates a color image.

The color image creating apparatus according to the first aspect creates a color image in the following manner. The intensity information and the color information acquired by the imaging are used for a pixel in the color visible image which has color information suitable for color display (namely, a pixel in the color visible image which has intensity equal to or higher than the predetermined value) so as to effect display in color. Further, the intensity information acquired by the imaging is used for a pixel in the color visible image which has color information unsuitable for color display (namely, a pixel in the color visible image which has lower intensity than the predetermined value) so as to effect display in grayscale.

Therefore, an image having better visibility may be obtained by using the color image creating apparatus according to the first aspect.

According to a second aspect of the invention, there is provided a color image creating apparatus that includes: an acquisition unit which acquires a color visible image from an imaging unit which images the color visible image based on light in a visible light range, the color visible image including a plurality of pixels which each include color information and intensity information; a color information arithmetic unit which interpolates color information for a pixel included in the color visible image which has lower intensity than a predetermined value using color information for pixels that are circumjacent to the pixel and that have intensity equal to or higher than the predetermined value, so as to calculate the color information for the pixel included in the color visible image which has lower intensity than the predetermined value; and a creation unit which uses the calculated color information and the intensity information acquired by the imaging for the pixel included in the color visible image whose color information is calculated by the color information arithmetic unit, and uses the color information acquired by the imaging and the intensity information acquired by the imaging for a pixel included in the color visible image whose color information is not calculated by the color information arithmetic unit, and creates a color image.

The color image creating apparatus according to the second aspect creates a color image in the following manner. The color information for the pixel in the color visible image (namely, the pixel in the color visible image which has the intensity lower than the predetermined value) which is unsuitable for color display is calculated by the interpolation using color information for pixels in the color visible image (namely, the pixels in the color visible image which have the intensity equal to or higher than the predetermined value) which is suitable for color display. The calculated color information and the intensity information acquired by the imaging are used for the pixel which is included in the color visible image and whose color information is calculated by the color information arithmetic unit. The color information and the intensity information that are acquired by the imaging are used for the pixel which is included in the color visible image and whose color information is not calculated by the color information arithmetic unit.

Therefore, an image having better visibility may be obtained by using the color image creating apparatus according to the second exemplary embodiment.

According to a third aspect of the invention, there is provided a color image creating apparatus that includes: an acquisition unit which acquires a color visible image from an imaging unit which images the color visible image based on light in a visible light range, the color visible image including a plurality of pixels which each include color information and intensity information; and a creation unit which uses the intensity information acquired by the imaging for a pixel included in the color visible image which has intensity equal to or higher than a predetermined value so as to effect display in grayscale, and uses the intensity information acquired by the imaging and the color information acquired by the imaging for a pixel included in the color visible image which has lower intensity than the predetermined value so as to effect display in color, and creates a color image.

The color image creating apparatus according to the third aspect creates a color image. The intensity information and the color information that are acquired by the imaging are used for the pixel in the color visible image (namely, the pixel in the color visible image which has the intensity lower than the predetermined value) which has the color information suitable for color display so as to effect display in color. The intensity information acquired by the imaging is used for the pixel in the color visible image (namely, the pixel in the color visible image which has the intensity equal to or higher than the predetermined value) which has the color information unsuitable for color display so as to effect display in grayscale.

Therefore, an image having better visibility may be obtained by using the color image creating apparatus according to the third aspect.

According to a fourth aspect of the invention, there is provided a color image creating apparatus that includes: an acquisition unit which acquires a color visible image from an imaging unit which images the color visible image based on light in a visible light range, the color visible image including a plurality of pixels which each include color information and intensity information; a color information arithmetic unit which interpolates color information for a pixel included in the color visible image which has intensity equal to or higher than a predetermined value using color information for pixels that are circumjacent to the pixel and that have lower intensity than the predetermined value, so as to calculate the color information for the pixel included in the color visible image which has intensity equal to or higher than the predetermined value; and a creation unit which uses the calculated color information and the intensity information acquired by the imaging for the pixel included in the color visible image whose color information is calculated by the color information arithmetic unit, and uses the color information acquired by the imaging and the intensity information acquired by the imaging for a pixel included in the color visible image whose color information is not calculated by the color information arithmetic unit, and creates a color image.

The color image creating apparatus according to the fourth aspect creates a color image in the following manner. The color information for the pixel in the color visible image (namely, the pixel in the color visible image which has the intensity equal to or higher than the predetermined value) which is unsuitable for color display is calculated by the interpolation using the color information for the pixel in the color visible image (namely, the pixel in the color visible image which has the intensity lower than the predetermined value) which is suitable for color display. The calculated color information and the intensity information acquired by the imaging are used for the pixel which is included in the color visible image and whose color information is calculated by the color information arithmetic unit. The color information and the intensity information that are acquired by the imaging are used for the pixel which is included in the color visible image and whose color information is not calculated by the color information arithmetic unit.

Therefore, an image having better visibility may be obtained by using the color image creating apparatus according to the fourth aspect.

According to a fifth aspect of the invention, there is provided a color image creating apparatus that includes: an acquisition unit which acquires a color visible image from an imaging unit which images the color visible image based on light in a visible light range, the color visible image including a plurality of pixels which each include color information, including a saturation level, and intensity information; and a creation unit which uses the intensity information acquired by the imaging and the color information acquired by the imaging for a pixel included in the color visible image which has a saturation level equal to or higher than a predetermined value so as to effect display in color, and uses the intensity information acquired by the imaging for a pixel included in the color visible image and which has a lower saturation level than the predetermined value so as to effect display in grayscale, and creates a color image.

The color image creating apparatus according to the fifth aspect creates a color image. The intensity information and the color information that are acquired by the imaging are used for the pixel in the color visible image (namely, the pixel in the color visible image which has the saturation equal to or higher than the predetermined value) which has color information suitable for color display so as to effect display in color. The intensity information acquired by the imaging is used for the pixel in the color visible image (namely, the pixel in the color visible image which has the lower saturation level than the predetermined value) which has color information unsuitable for color display so as to effect display in grayscale.

Therefore, an image having better visibility may be obtained by using the color image creating apparatus according to the fifth aspect.

According to a sixth aspect of the invention, there is provided a color image creating apparatus that includes: an acquisition unit which acquires a color visible image from an imaging unit which images the color visible image based on light in a visible light range, the color visible image including a plurality of pixels which each include color information, including a saturation level, and intensity information; a color information arithmetic unit which interpolates color information for a pixel included in the color visible image and which has a lower saturation level than a predetermined value using color information for pixels that are circumjacent to the pixel and that have a saturation level equal to or higher than the predetermined value, so as to calculate the color information for the pixel included in the color visible image and which has a lower saturation level than the predetermined value; and a creation unit which uses the calculated color information and the intensity information acquired by the imaging for the pixel included in the color visible image whose color information is calculated by the color information arithmetic unit, and uses the color information acquired by the imaging and the intensity information acquired by the imaging for a pixel included in the color visible image whose color information is not calculated by the color information arithmetic unit, and creates a color image.

The color image creating apparatus according to the sixth aspect creates a color image in the following manner. The color information for the pixel in the color visible image (namely, the pixel in the color visible image which has the lower saturation level than the predetermined value) which ahs color information unsuitable for color display is calculated by the interpolation using the color information for the pixels in the color visible image (namely, the pixels in the color visible image which have the saturation equal to or higher than the predetermined value) which has color information suitable for color display. The calculated color information and the intensity information acquired by the imaging are used for the pixel which is included in the color visible image and whose color information is calculated by the color information arithmetic unit. The color information and the intensity information that are acquired by the imaging are used for the pixel which is included in the color visible image and whose color information is not calculated by the color information arithmetic unit.

Therefore, an image having better visibility may be obtained by using the color image creating apparatus according to the sixth aspect.

According to a seventh aspect of the invention, there is provided a color image creating apparatus that includes: an acquisition unit which acquires a color visible image from an imaging unit which images the color visible image based on light in a visible light range, the color visible image including a plurality of pixels which each include color information and intensity information; and a creation unit which uses the intensity information acquired by the imaging and the color information acquired by the imaging for a pixel included in the color visible image which has intensity equal to or higher than a first predetermined value and lower than a second predetermined value which is larger than the first predetermined value so as to effect display in color, and uses the intensity information acquired by the imaging for a pixel included in the color visible image which has lower intensity than the first predetermined value or intensity equal to or higher than the second predetermined value so as to effect display in grayscale, and creates a color image.

The color image creating apparatus according to the seventh aspect creates a color image. The intensity information and the color information that are acquired by the imaging are used for the pixel in a color visible image (namely, the pixel in the color visible image which has the intensity equal to or higher than the first predetermined value and lower than the second predetermined value) which has color information suitable for color display so as to effect display in color. The intensity information acquired by the imaging is used for the pixel in the color visible image (namely, the pixel in the color visible image which has the intensity lower than the first predetermined value or the intensity equal to or higher than the second predetermined value) which has color information unsuitable for color display so as to effect display in grayscale.

Therefore, an image having better visibility may be obtained by using the color image creating apparatus according to the seventh aspect.

According to an eighth aspect of the invention, there is provided a color image creating apparatus that includes: an acquisition unit which acquires a color visible image from an imaging unit which images the color visible image based on light in a visible light range, the color visible image including a plurality of pixels which each include color information and intensity information; a color information arithmetic unit which interpolates color information for a pixel included in the color visible image which has lower intensity than a first predetermined value or intensity equal to or higher than a second predetermined value, which is larger than the first predetermined value, using color information for pixels that are circumjacent to the pixel and that have intensity equal to or higher than the first predetermined value and lower than the second predetermined value, so as to calculate the color information for the pixel included in the color visible image which has lower intensity than the first predetermined value or intensity equal to or higher than the second predetermined value; and a creation unit which uses the calculated color information and the intensity information acquired by the imaging for the pixel included in the color visible image whose color information is calculated by the color information arithmetic unit, and uses the color information acquired by the imaging and the intensity information acquired by the imaging for a pixel included in the color visible image whose color information is not calculated by the color information arithmetic unit, and creates a color image.

The color image creating apparatus according to the eighth aspect creates a color image in the following manner. The color information for the pixel in the color visible image (namely, the pixel in the color visible image which has the intensity lower than the predetermined value or intensity equal to or higher than the second predetermined value) which has color information suitable for color display is calculated by the interpolation using the color information for the pixels in the color visible image (namely, the pixels in the color visible image which have the intensity equal to or higher than the first predetermined value and lower than the second predetermined value) which have color information suitable for color display. The calculated color information and the intensity information acquired by the imaging are used for the pixel which is included in the color visible image and whose color information is calculated by the color information arithmetic unit. The color information and the intensity information that are acquired by the imaging are used for the pixel which is included in the color visible image and whose color information is not calculated by the color information arithmetic unit.

Therefore, an image having better visibility may be obtained by using the color image creating apparatus according to the eighth aspect.

According to a ninth aspect of the invention, there is provided a color image creating apparatus that includes: an acquisition unit which acquires a color visible image from an imaging unit which images the color visible image based on light in a visible light range, the color visible image including a plurality of pixels which each include color information and intensity information; and a creation unit which uses the intensity information acquired by the imaging and the color information acquired by the imaging for a pixel included in the color visible image which includes color information representing red so as to effect display in color, and uses the intensity information acquired by the imaging for a pixel included in the color visible image which includes color information representing a color other than red so as to effect display in grayscale, and creates a color image.

The color image creating apparatus according to the ninth aspect creates a color image. The intensity information and the color information that are acquired by the imaging are used for the pixel in the color visible image whose color information represents a color of signal lamps, a color of signs, and a color of tail lamps (the color is, for example, red) to which a driver of a vehicle should pay an attention particularly at night (namely, the pixel having the color information representing red) so as to effect display in color. The intensity information acquired by the imaging is used for a pixel which has the color information which represents a color to which the driver of the vehicle does not have to pay a special attention (namely, the pixel which has color information which represents a color other than red) so as to effect display in grayscale.

Therefore, an image having better visibility may be obtained by using the color image creating apparatus according to the ninth aspect.

According to a tenth aspect of the invention, there is provided a color image creating apparatus that includes: an acquisition unit which acquires a color visible image from an imaging unit which images the color visible image based on light in a visible light range, the color visible image including a plurality of pixels which each include color information and intensity information; and a creation unit which uses the intensity information acquired by the imaging and the color information acquired by the imaging for a pixel included in the color visible image which includes color information representing at least one of blue, yellow, green, red, or orange so as to effect display in color, and uses the intensity information acquired by the imaging for a pixel included in the color visible image which includes color information representing a color other than the at least one of blue, yellow, green, red, or orange so as to effect display in grayscale, and creates a color image.

The color image creating apparatus according to the tenth aspect creates a color image. The intensity information and the color information that are acquired by the imaging are used for the pixel in the color visible image whose color information represents a color of signal lamps, a color of signs, a color of tail lamps, and a color of street light (the color includes, for example, blue, yellow, green, red, and orange) to which a driver of a vehicle should pay an attention particularly at night (namely, the pixel which has the color information which represents at least one of blue, yellow, green, red, or orange) so as to effect display in color. The intensity information acquired by the imaging is used for the pixel which has the color information which represents a color to which the driver of the vehicle does not have to pay a special attention (namely, the pixel which has color information which represents a color other than at least one of blue, yellow, green, red, or orange) so as to effect display in grayscale.

Therefore, an image having better visibility may be obtained by using the color image creating apparatus according to the tenth aspect.

According to an eleventh aspect of the invention, in the color image creating apparatus from the first to tenth aspects, the imaging unit further may image an infrared image including a plurality of pixels which each include intensity information based on light in a near-infrared range; and the acquisition unit further may acquire the infrared image from the imaging unit, the color image creating apparatus further may include a replacement unit which replaces the intensity of a pixel included in the color image created by the creation unit which has lower intensity than an intensity of a corresponding pixel of the infrared image, with the intensity of the corresponding pixel or with an average mean of the intensity of the pixel included in the color image and the intensity of the corresponding pixel, and the creation unit may use intensity information which represents intensity after replacement and corresponding color information of the color image for the pixel of the color image whose intensity is replaced by the replacement unit, and use the intensity information acquired by the imaging and corresponding color information of the color image for a pixel of the color image whose intensity is not replaced by the replacement unit, and create a second color image.

The color image creating apparatus according to the eleventh aspect further creates a color image in the following manner. The intensity of the pixel in the color visible image is compared with the intensity of the corresponding pixel in the infrared image. The intensity of the pixel in the color visible image which is lower than the intensity of the corresponding pixel in the infrared image is replaced by intensity that makes the visibility better.

When the replacement unit according to the eleventh aspect performs replacement using the weighted mean of the intensity of the pixel in the color image and the intensity of the corresponding pixel in the infrared image, the saturation of the intensity is repressed.

Therefore, an image having better visibility may be obtained by using the color image creating apparatus according to the eleventh aspect.

A color image creating apparatus according to a twelfth aspect, there is provided a color image creating apparatus that includes: an acquisition unit which acquires a color visible image and an infrared image from an imaging unit which images the color visible image based on light in a visible light range and the infrared image based on light in a near-infrared range, the color visible image including a plurality of pixels which each include color information and intensity information, and the infrared image including a plurality of pixels which each include intensity information; a replacement unit which replaces the intensity of a pixel included in the color visible image acquired by the acquisition unit which has lower intensity than an intensity of a corresponding pixel of the infrared image, with the intensity of the corresponding pixel, or with a weighted mean of the intensity of the pixel included in the color visible image and the intensity of the corresponding pixel of the infrared image; and a creation unit which uses intensity information which represents intensity after replacement and the color information acquired by the imaging for the pixel of the color visible image whose intensity is replaced by the replacement unit, and uses the intensity information acquired by the imaging and the color information acquired by the imaging for a pixel of the color visible image whose intensity is not replaced by the replacement unit, and creates a color image.

The color image creating apparatus according to the twelfth aspect further creates a color image in the following manner. The intensity of the pixel in the color visible image is compared with the intensity of the corresponding pixel in the infrared image. The intensity of the pixel which is included in the color visible image and which has intensity lower than the intensity of the corresponding pixel in the infrared image is replaced with intensity that makes the visibility better.

When the replacement unit according to the twelfth aspect performs replacement using the weighted mean of the intensity of the pixel in the color image and the intensity of the pixels in the infrared image, the saturation of the intensity is repressed.

Therefore, an image having better visibility may be obtained by using the color image creating apparatus according to the twelfth aspect.

According to a thirteenth aspect of the invention, there is provided a computer readable medium storing a program causing a computer to execute a process for creating a color image, the process including: acquiring a color visible image including a plurality of pixels, which each include color information and intensity information, from an imaging unit which images the color visible image based on light in a visible light range; and using the intensity information acquired by the imaging and the color information acquired by the imaging for a pixel included in the color visible image which has intensity equal to or higher than a predetermined value so as to effect display in color, and using the intensity information acquired by the imaging for a pixel included in the color visible image which has lower intensity than the predetermined value so as to effect display in grayscale, and creating a color image.

According to the program of the thirteenth aspect, an image having better visibility may be obtained by a similar principle to that in the first aspect.

According to a fourteenth aspect of the invention, there is provided a computer readable medium storing a program causing a computer to execute a process for creating a color image, the process including: acquiring a color visible image including a plurality of pixels, which each include color information and intensity information, from an imaging unit which images the color visible image based on light in a visible light range; interpolating color information for a pixel included in the color visible image which has lower intensity than a predetermined value using color information for pixels that are circumjacent to the pixel and that have intensity equal to or higher than the predetermined value so as to calculate the color information for the pixel included in the color visible image which has lower intensity than the predetermined value; and using the calculated color information and the intensity information acquired by the imaging for the pixel included in the color visible image whose color information is calculated, and using the color information acquired by the imaging and the intensity information acquired by the imaging for a pixel included in the color visible image whose color information is not calculated, and creating a color image.

According to the program of the fourteenth aspect, an image having better visibility may be obtained by a similar principle to that in the second aspect.

According to a fifteenth aspect of the invention, there is provided a computer readable medium storing a program causing a computer to execute a process for creating a color image, the process including: acquiring a color visible image including a plurality of pixels, which each include color information and intensity information, from an imaging unit which images the color visible image based on light in a visible light range; and using the intensity information acquired by the imaging for a pixel included in the color visible image which has intensity equal to or higher than a predetermined value so as to effect display in grayscale, and using the intensity information acquired by the imaging and the color information acquired by the imaging for a pixel included in the color visible image which has lower intensity than the predetermined value so as to effect display in color, and creating a color image.

According to the program of the fifteenth aspect, an images having better visibility may be obtained by a similar principle to that in the third aspect.

According to a sixteenth aspect of the invention, there is provided a computer readable medium storing a program causing a computer to execute a process for creating a color image, the process including: acquiring a color visible image including a plurality of pixels, which each include color information and intensity information, from an imaging unit which images the color visible image based on light in a visible light range; interpolating color information for a pixel included in the color visible image which has intensity equal to or higher than a predetermined value using color information for pixels that are circumjacent to the pixel and that have lower intensity than the predetermined value so as to calculate the color information for the pixel included in the color visible image which has intensity equal to or higher than the predetermined value; and using the calculated color information and the intensity information acquired by the imaging for the pixel included in the color visible image whose color information is calculated, and using the color information acquired by the imaging and the intensity information acquired by the imaging for a pixel included in the color visible image whose color information is not calculated, and creating a color image.

According to the program of the sixteenth aspect, an image having better visibility may be obtained by a similar principle to that in the fourth aspect.

According to a seventeenth aspect of the invention, there is provided a computer readable medium storing a program causing a computer to execute a process for creating a color image, the process including: acquiring a color visible image including a plurality of pixels, which each include color information including a saturation level and intensity information, from an imaging unit which images the color visible image based on light in a visible light range; and using the intensity information acquired by the imaging and the color information acquired by the imaging for a pixel included in the color visible image which has a saturation level equal to or higher than a predetermined value so as to effect display in color, and using the intensity information acquired by the imaging for a pixel included in the color visible image which has a lower saturation level than the predetermined value so as to effect display in grayscale, and creating a color image.

According to the program of the seventeenth aspect, an image having better visibility may be obtained by a similar principle to that in the fifth aspect.

According to an eighteenth aspect of the invention, there is provided a computer readable medium storing a program causing a computer to execute a process for creating a color image, the process including: acquiring a color visible image including a plurality of pixels, which each include color information including a saturation level and intensity information, from an imaging unit which images the color visible image based on light in a visible light range; interpolating color information for a pixel included in the color visible image which has a lower saturation level than a predetermined value using color information for pixels that are circumjacent to the pixel and that have a saturation level equal to or higher than the predetermined value so as to calculate the color information for the pixel included in the color visible image which has a lower saturation level than the predetermined value; and using the calculated color information and the intensity information acquired by the imaging for the pixel included in the color visible image whose color information is calculated, and using the color information acquired by the imaging and the intensity information acquired by the imaging for a pixel included in the color visible image whose color information is not calculated, and creating a color image.

According to the program of the eighteenth aspect, an image having better visibility may be obtained by a similar principle to that in the sixth aspect.

According to a nineteenth aspect of the invention, there is provided a computer readable medium storing a program causing a computer to execute a process for creating a color image, the process including: acquiring a color visible image including a plurality of pixels, which each include color information and intensity information, from an imaging unit which images the color visible image based on light in a visible light range; and using the intensity information acquired by the imaging and the color information acquired by the imaging for a pixel included in the color visible image which has intensity equal to or higher than a first predetermined value and lower than a second predetermined value which is larger than the first predetermined value so as to effect display in color, and using the intensity information acquired by the imaging for a pixel included in the color visible image which has lower intensity than the first predetermined value or intensity equal to or higher than the second predetermined value so as to effect display in grayscale, and creating a color image.

According to the program of the nineteenth aspect, an image having better visibility may be obtained by a similar principle to that in the seventh aspect.

According to a twentieth aspect of the invention, there is provided a computer readable medium storing a program causing a computer to execute a process for creating a color image, the process including: acquiring a color visible image including a plurality of pixels, which each include color information and intensity information, from an imaging unit which images the color visible image based on light in a visible light range; interpolating color information for a pixel included in the color visible image which has lower intensity than a first predetermined value or intensity equal to or higher than a second predetermined value which is larger than the first predetermined value using color information for pixels that are circumjacent to the pixel and that have intensity equal to or higher than the first predetermined value and lower than the second predetermined value so as to calculate the color information for the pixel included in the color visible image which has lower intensity than the first predetermined value or intensity equal to or higher than the second predetermined value; and using the calculated color information and the intensity information acquired by the imaging for the pixel included in the color visible image whose color information is calculated, and using the color information acquired by the imaging and the intensity information acquired by the imaging for a pixel included in the color visible image whose color information is not calculated, and creating a color image.

According to the program of the twentieth aspect, an image having better visibility may be obtained by a similar principle to that in the eighth aspect.

According to a twenty-first aspect of the invention, there is provided a computer readable medium storing a program causing a computer to execute a process for creating a color image, the process including: acquiring a color visible image including a plurality of pixels, which each include color information and intensity information, from an imaging unit which images the color visible image based on light in a visible light range; and using the intensity information acquired by the imaging and the color information acquired by the imaging for a pixel included in the color visible image which has color information representing red so as to effect display in color, and using the intensity information acquired by the imaging for a pixel included in the color visible image which has color information representing a color other than red so as to effect display in grayscale, and creating a color image.

According to the program of the twenty-first aspect, an image having better visibility may be obtained by a similar principle to that in the ninth aspect.

According to a twenty-second aspect of the invention, there is provided a computer readable medium storing a program causing a computer to execute a process for creating a color image, the process including: acquiring a color visible image including a plurality of pixels, which each include color information and intensity information, from an imaging unit which images the color visible image based on light in a visible light range; and using the intensity information acquired by the imaging and the color information acquired by the imaging for a pixel included in the color visible image which has color information representing at least one of blue, yellow, green, red, or orange so as to effect display in color, and using the intensity information acquired by the imaging for a pixel included in the color visible image which has color information representing a color other than the at least one of blue, yellow, green, red, or orange so as to effect display in grayscale, and creating a color image.

According to the program of the twenty-second aspect, an image having better visibility may be obtained by a similar principle to that in the tenth aspect.

According to a twenty-third aspect of the invention, there is provided a computer readable medium storing a program causing a computer to execute a process for creating a color image, the process including: acquiring a color visible image including a plurality of pixels, which each include color information and intensity information, and an infrared image including a plurality of pixels, which each include intensity information, from an imaging unit which images the color visible image based on light in a visible light range and the infrared image based on light in a near-infrared range; replacing the intensity of a pixel included in the acquired color visible image which has lower intensity than an intensity of a corresponding pixel of the infrared image, with the intensity of the corresponding pixel, or with a weighted mean of the intensity of the pixel included in the color visible image and the intensity of the corresponding pixel of the infrared image; and using intensity information which represents intensity after replacement and the color information acquired by the imaging for the pixel of the color visible image whose intensity is replaced, and using the intensity information acquired by the imaging and the color information acquired by the imaging for a pixel of the color visible image whose intensity is not replaced, and creating a color image.

According to the program of the twenty-third aspect, an image having better visibility may be obtained by a similar principle to that in the twelfth aspect.

As described above, an image having better visibility may be obtained by using the color image creating apparatus and the program of the invention.

Embodiments of the present invention are described above, but the present invention is not limited to the embodiments as will be clear to those skilled in the art.

What is claimed is:

1. A color image creating apparatus comprising:
an acquisition unit which acquires a color visible image from an imaging unit which images the color visible image based on light in a visible light range, the color visible image comprising a plurality of pixels which each include color information and intensity information; and
a creation unit which uses the intensity information acquired by the imaging and the color information acquired by the imaging for a pixel included in the color visible image which has intensity equal to or higher than a predetermined value so as to effect display in color, and uses the intensity information acquired by the imaging for a pixel included in the color visible image which has lower intensity than the predetermined value so as to effect display in grayscale, and creates a color image.

2. The color image creating apparatus of claim 1, wherein:
the imaging unit further images an infrared image comprising a plurality of pixels which each include intensity information based on light in a near-infrared range; and
the acquisition unit further acquires the infrared image from the imaging unit,
the color image creating apparatus further comprising:
a replacement unit which replaces the intensity of a pixel included in the color image created by the creation unit which has lower intensity than an intensity of a corresponding pixel of the infrared image, with the intensity of the corresponding pixel or with an average mean of the intensity of the pixel included in the color image and the intensity of the corresponding pixel,
wherein the creation unit uses intensity information which represents intensity after replacement and corresponding color information of the color image for the pixel of the color image whose intensity is replaced by the replacement unit, and uses the intensity information acquired by the imaging and corresponding color information of the color image for a pixel of the color image whose intensity is not replaced by the replacement unit, and creates a second color image.

3. A color image creating apparatus comprising:
an acquisition unit which acquires a color visible image from an imaging unit which images the color visible image based on light in a visible light range, the color visible image comprising a plurality of pixels which each include color information and intensity information;
a color information arithmetic unit which interpolates color information for a pixel included in the color visible image which has lower intensity than a predetermined value using color information for pixels that are circumjacent to the pixel and that have intensity equal to or higher than the predetermined value, so as to calculate the color information for the pixel included in the color visible image which has lower intensity than the predetermined value; and
a creation unit which uses the calculated color information and the intensity information acquired by the imaging for the pixel included in the color visible image whose color information is calculated by the color information arithmetic unit, and uses the color information acquired by the imaging and the intensity information acquired by the imaging for a pixel included in the color visible image whose color information is not calculated by the color information arithmetic unit, and creates a color image.

4. The color image creating apparatus of claim 3, wherein:
the imaging unit further images an infrared image comprising a plurality of pixels which each include intensity information based on light in a near-infrared range; and
the acquisition unit further acquires the infrared image from the imaging unit,
the color image creating apparatus further comprising:
a replacement unit which replaces the intensity of a pixel included in the color image created by the creation unit which has lower intensity than an intensity of a corresponding pixel of the infrared image, with the intensity of the corresponding pixel or with an average mean of the intensity of the pixel included in the color image and the intensity of the corresponding pixel,
wherein the creation unit uses intensity information which represents intensity after replacement and corresponding color information of the color image for the pixel of the color image whose intensity is replaced by the replacement unit, and uses the intensity information acquired by the imaging and corresponding color information of the color image for a pixel of the color image whose intensity is not replaced by the replacement unit, and creates a second color image.

5. A color image creating apparatus comprising:
an acquisition unit which acquires a color visible image from an imaging unit which images the color visible image based on light in a visible light range, the color visible image comprising a plurality of pixels which each include color information and intensity information; and
a creation unit which uses the intensity information acquired by the imaging for a pixel included in the color visible image which has intensity equal to or higher than a predetermined value so as to effect display in grayscale, and uses the intensity information acquired by the imaging and the color information acquired by the imaging for a pixel included in the color visible image which has lower intensity than the predetermined value so as to effect display in color, and creates a color image.

6. The color image creating apparatus of claim 5, wherein:
the imaging unit further images an infrared image comprising a plurality of pixels which each include intensity information based on light in a near-infrared range; and
the acquisition unit further acquires the infrared image from the imaging unit,
the color image creating apparatus further comprising:
a replacement unit which replaces the intensity of a pixel included in the color image created by the creation unit which has lower intensity than an intensity of a corresponding pixel of the infrared image, with the intensity of the corresponding pixel or with an average mean of the intensity of the pixel included in the color image and the intensity of the corresponding pixel,
wherein the creation unit uses intensity information which represents intensity after replacement and corresponding color information of the color image for the pixel of the color image whose intensity is replaced by the replacement unit, and uses the intensity information acquired by the imaging and corresponding color information of the color image for a pixel of the color image whose intensity is not replaced by the replacement unit, and creates a second color image.

7. A color image creating apparatus comprising:
an acquisition unit which acquires a color visible image from an imaging unit which images the color visible image based on light in a visible light range, the color visible image comprising a plurality of pixels which each include color information and intensity information;
a color information arithmetic unit which interpolates color information for a pixel included in the color visible image which has intensity equal to or higher than a predetermined value using color information for pixels that are circumjacent to the pixel and that have lower intensity than the predetermined value, so as to calculate the color information for the pixel included in the color visible image which has intensity equal to or higher than the predetermined value; and
a creation unit which uses the calculated color information and the intensity information acquired by the imaging for the pixel included in the color visible image whose color information is calculated by the color information arithmetic unit, and uses the color information acquired by the imaging and the intensity information acquired by the imaging for a pixel included in the color visible image whose color information is not calculated by the color information arithmetic unit, and creates a color image.

8. The color image creating apparatus of claim 7, wherein:
the imaging unit further images an infrared image comprising a plurality of pixels which each include intensity information based on light in a near-infrared range; and
the acquisition unit further acquires the infrared image from the imaging unit,
the color image creating apparatus further comprising:
a replacement unit which replaces the intensity of a pixel included in the color image created by the creation unit which has lower intensity than an intensity of a corresponding pixel of the infrared image, with the intensity of the corresponding pixel or with an average mean of the intensity of the pixel included in the color image and the intensity of the corresponding pixel,
wherein the creation unit uses intensity information which represents intensity after replacement and corresponding color information of the color image for the pixel of the color image whose intensity is replaced by the replacement unit, and uses the intensity information acquired by the imaging and corresponding color information of the color image for a pixel of the color image whose intensity is not replaced by the replacement unit, and creates a second color image.

9. A color image creating apparatus comprising:
an acquisition unit which acquires a color visible image from an imaging unit which images the color visible image based on light in a visible light range, the color visible image comprising a plurality of pixels which each include color information, including a saturation level, and intensity information; and
a creation unit which uses the intensity information acquired by the imaging and the color information acquired by the imaging for a pixel included in the color visible image which has a saturation level equal to or higher than a predetermined value so as to effect display in color, and uses the intensity information acquired by the imaging for a pixel included in the color visible image and which has a lower saturation level than the predetermined value so as to effect display in grayscale, and creates a color image.

10. The color image creating apparatus of claim 9, wherein:
the imaging unit further images an infrared image comprising a plurality of pixels which each include intensity information based on light in a near-infrared range; and
the acquisition unit further acquires the infrared image from the imaging unit,
the color image creating apparatus further comprising:
a replacement unit which replaces the intensity of a pixel included in the color image created by the creation unit which has lower intensity than an intensity of a corresponding pixel of the infrared image, with the intensity of the corresponding pixel or with an average mean of the intensity of the pixel included in the color image and the intensity of the corresponding pixel,
wherein the creation unit uses intensity information which represents intensity after replacement and corresponding color information of the color image for the pixel of the color image whose intensity is replaced by the replacement unit, and uses the intensity information acquired by the imaging and corresponding color information of the color image for a pixel of the color image whose intensity is not replaced by the replacement unit, and creates a second color image.

11. A color image creating apparatus comprising:
an acquisition unit which acquires a color visible image from an imaging unit which images the color visible image based on light in a visible light range, the color visible image comprising a plurality of pixels which each include color information, including a saturation level, and intensity information;
a color information arithmetic unit which interpolates color information for a pixel included in the color visible image and which has a lower saturation level than a predetermined value using color information for pixels that are circumjacent to the pixel and that have a saturation level equal to or higher than the predetermined value, so as to calculate the color information for the pixel included in the color visible image and which has a lower saturation level than the predetermined value; and
a creation unit which uses the calculated color information and the intensity information acquired by the imaging for the pixel included in the color visible image whose color information is calculated by the color information arithmetic unit, and uses the color information acquired by the imaging and the intensity information acquired by the imaging for a pixel included in the color visible image whose color information is not calculated by the color information arithmetic unit, and creates a color image.

12. The color image creating apparatus of claim 11, wherein:
the imaging unit further images an infrared image comprising a plurality of pixels which each include intensity information based on light in a near-infrared range; and
the acquisition unit further acquires the infrared image from the imaging unit,
the color image creating apparatus further comprising:
a replacement unit which replaces the intensity of a pixel included in the color image created by the creation unit which has lower intensity than an intensity of a corresponding pixel of the infrared image, with the intensity of the corresponding pixel or with an average mean of the intensity of the pixel included in the color image and the intensity of the corresponding pixel,
wherein the creation unit uses intensity information which represents intensity after replacement and corresponding color information of the color image for the pixel of the color image whose intensity is replaced by the replacement unit, and uses the intensity information acquired by the imaging and corresponding color information of the color image for a pixel of the color image whose intensity is not replaced by the replacement unit, and creates a second color image.

13. A color image creating apparatus comprising:
an acquisition unit which acquires a color visible image from an imaging unit which images the color visible image based on light in a visible light range, the color visible image comprising a plurality of pixels which each include color information and intensity information; and
a creation unit which uses the intensity information acquired by the imaging and the color information acquired by the imaging for a pixel included in the color visible image which has intensity equal to or higher than a first predetermined value and lower than a second predetermined value which is larger than the first predetermined value so as to effect display in color, and uses the intensity information acquired by the imaging for a pixel included in the color visible image which has lower intensity than the first predetermined value or intensity equal to or higher than the second predetermined value so as to effect display in grayscale, and creates a color image.

14. The color image creating apparatus of claim 13, wherein:
the imaging unit further images an infrared image comprising a plurality of pixels which each include intensity information based on light in a near-infrared range; and
the acquisition unit further acquires the infrared image from the imaging unit,
the color image creating apparatus further comprising:
a replacement unit which replaces the intensity of a pixel included in the color image created by the creation unit which has lower intensity than an intensity of a corresponding pixel of the infrared image, with the intensity of the corresponding pixel or with an average mean of the intensity of the pixel included in the color image and the intensity of the corresponding pixel,
wherein the creation unit uses intensity information which represents intensity after replacement and corresponding color information of the color image for the pixel of the color image whose intensity is replaced by the replacement unit, and uses the intensity information acquired by the imaging and corresponding color information of the color image for a pixel of the color image whose intensity is not replaced by the replacement unit, and creates a second color image.

15. A color image creating apparatus comprising:
an acquisition unit which acquires a color visible image from an imaging unit which images the color visible image based on light in a visible light range, the color visible image comprising a plurality of pixels which each include color information and intensity information;
a color information arithmetic unit which interpolates color information for a pixel included in the color visible image which has lower intensity than a first predetermined value or intensity equal to or higher than a second predetermined value, which is larger than the first predetermined value, using color information for pixels that are circumjacent to the pixel and that have intensity equal to or higher than the first predetermined value and lower than the second predetermined value, so as to calculate the color information for the pixel included in the color visible image which has lower intensity than the first predetermined value or intensity equal to or higher than the second predetermined value; and
a creation unit which uses the calculated color information and the intensity information acquired by the imaging for the pixel included in the color visible image whose color information is calculated by the color information arithmetic unit, and uses the color information acquired by the imaging and the intensity information acquired by the imaging for a pixel included in the color visible image whose color information is not calculated by the color information arithmetic unit, and creates a color image.

16. The color image creating apparatus of claim 15, wherein:
the imaging unit further images an infrared image comprising a plurality of pixels which each include intensity information based on light in a near-infrared range; and
the acquisition unit further acquires the infrared image from the imaging unit,
the color image creating apparatus further comprising:
a replacement unit which replaces the intensity of a pixel included in the color image created by the creation unit which has lower intensity than an intensity of a corresponding pixel of the infrared image, with the intensity of the corresponding pixel or with an average mean of the intensity of the pixel included in the color image and the intensity of the corresponding pixel,
wherein the creation unit uses intensity information which represents intensity after replacement and corresponding color information of the color image for the pixel of the color image whose intensity is replaced by the replacement unit, and uses the intensity information acquired by the imaging and corresponding color information of the color image for a pixel of the color image whose intensity is not replaced by the replacement unit, and creates a second color image.

17. A color image creating apparatus comprising:
an acquisition unit which acquires a color visible image from an imaging unit which images the color visible image based on light in a visible light range, the color visible image comprising a plurality of pixels which each include color information and intensity information; and
a creation unit which uses the intensity information acquired by the imaging and the color information acquired by the imaging for a pixel included in the color visible image which includes color information representing red so as to effect display in color, and uses the intensity information acquired by the imaging for a pixel included in the color visible image which includes color information representing a color other than red so as to effect display in grayscale, and creates a color image.

18. The color image creating apparatus of claim 17, wherein:
the imaging unit further images an infrared image comprising a plurality of pixels which each include intensity information based on light in a near-infrared range; and
the acquisition unit further acquires the infrared image from the imaging unit,
the color image creating apparatus further comprising:
a replacement unit which replaces the intensity of a pixel included in the color image created by the creation unit which has lower intensity than an intensity of a corresponding pixel of the infrared image, with the intensity of the corresponding pixel or with an average mean of the intensity of the pixel included in the color image and the intensity of the corresponding pixel,
wherein the creation unit uses intensity information which represents intensity after replacement and corresponding color information of the color image for the pixel of the color image whose intensity is replaced by the replacement unit, and uses the intensity information acquired by the imaging and corresponding color information of the color image for a pixel of the color image whose intensity is not replaced by the replacement unit, and creates a second color image.

19. A color image creating apparatus comprising:
an acquisition unit which acquires a color visible image from an imaging unit which images the color visible image based on light in a visible light range, the color visible image comprising a plurality of pixels which each include color information and intensity information; and
a creation unit which uses the intensity information acquired by the imaging and the color information acquired by the imaging for a pixel included in the color visible image which includes color information representing at least one of blue, yellow, green, red, or orange so as to effect display in color, and uses the intensity information acquired by the imaging for a pixel included in the color visible image which includes color information representing a color other than the at least one of blue, yellow, green, red, or orange so as to effect display in grayscale, and creates a color image.

20. The color image creating apparatus of claim 19, wherein:
the imaging unit further images an infrared image comprising a plurality of pixels which each include intensity information based on light in a near-infrared range; and
the acquisition unit further acquires the infrared image from the imaging unit,
the color image creating apparatus further comprising:
a replacement unit which replaces the intensity of a pixel included in the color image created by the creation unit which has lower intensity than an intensity of a corresponding pixel of the infrared image, with the intensity of the corresponding pixel or with an average mean of the intensity of the pixel included in the color image and the intensity of the corresponding pixel,
wherein the creation unit uses intensity information which represents intensity after replacement and corresponding color information of the color image for the pixel of the color image whose intensity is replaced by the replacement unit, and uses the intensity information acquired by the imaging and corresponding color information of the color image for a pixel of the color image whose intensity is not replaced by the replacement unit, and creates a second color image.

21. A color image creating apparatus comprising:
an acquisition unit which acquires a color visible image and an infrared image from an imaging unit which images the color visible image based on light in a visible light range and the infrared image based on light in a near-infrared range, the color visible image comprising a plurality of pixels which each include color information and intensity information, and the infrared image comprising a plurality of pixels which each include intensity information;
a replacement unit which replaces the intensity of a pixel included in the color visible image acquired by the acquisition unit which has lower intensity than an intensity of a corresponding pixel of the infrared image, with the intensity of the corresponding pixel, or with a weighted mean of the intensity of the pixel included in the color visible image and the intensity of the corresponding pixel of the infrared image; and
a creation unit which uses intensity information which represents intensity after replacement and the color information acquired by the imaging for the pixel of the color visible image whose intensity is replaced by the replacement unit, and uses the intensity information acquired by the imaging and the color information acquired by the imaging for a pixel of the color visible image whose intensity is not replaced by the replacement unit, and creates a color image.
